(19) United States
(12) Patent Application Publication
(10) Pub. No.: US 2025/0037740 A1
(43) Pub. Date: Jan. 30, 2025

(54) MAGNETIC RECORDING MEDIUM

(71) Applicant: Sony Group Corporation, Tokyo (JP)

(72) Inventors: Minoru YAMAGA, Tokyo (JP); Tooru SATO, Tokyo (JP); Takahiro TAKAYAMA, Tokyo (JP)

(21) Appl. No.: 18/700,163

(22) PCT Filed: Oct. 25, 2022
(86) PCT No.: PCT/JP2022/039751

§ 371 Date: Sep. 23, 2024

(30) Foreign Application Priority Data
Nov. 1, 2021 (JP) 2021-178663

(51) Int. Cl. G11B 5/706

(52) U.S. Cl. CPC G11B 5/70678

(57) ABSTRACT

An object of the present technology is to provide a magnetic recording medium that has excellent travelling stability even when preserved in a high-temperature environment.

The present technology provides a magnetic recording medium, in which an average value A_{(E″)} of loss elastic moduli E″ in a temperature range of 60° C. to 65° C. when dynamic mechanical analysis is performed on the magnetic recording medium at a frequency of 10 Hz and a heating rate of 2° C./min is 0.06 GPa or less, and an average height Rpk of protruding peaks measured using a non-contact profilometer using optical interference is 2.4 nm or less.

### TECHNICAL FIELD

The present technology relates to a magnetic recording medium.

### BACKGROUND ART

For example, with the development of IoT, big data, and artificial intelligence, the amount of data to be collected and stored has increased significantly. A magnetic recording medium is often used as a medium for recording a large amount of data.

With respect to a magnetic recording medium, various technologies have been proposed so far. For example, the following Patent Literature 1 describes a magnetic recording medium capable of performing reproduction or recording favorably even after long-term preservation. The magnetic recording medium described in the same literature has a difference between the maximum value and the minimum value of a viscosity term E″ of 0.18 GPa or less, the viscosity term E″ being in the temperature range of 0° C. to 80° C. when dynamic mechanical analysis is performed on the magnetic recording medium at a frequency of 10 Hz and a heating rate of 2° C./min.

### CITATION LIST

### Patent Literature

Patent Literature 1: Japanese Patent No. 6766988

### DISCLOSURE OF INVENTION

### Technical Problem

One object of the present technology is to provide a magnetic recording tape that exhibits excellent travelling stability even when preserved in a high-temperature environment.

### Solution to Problem

The present technology provides a magnetic recording medium, in which
an average value A_{(E″)} of loss elastic moduli E″ in a temperature range of 60° C. to 65° C. when dynamic mechanical analysis is performed on the magnetic recording medium at a frequency of 10 Hz and a heating rate of 2° C./min is 0.06 GPa or less, and
an average height Rpk of protruding peaks measured using a non-contact profilometer using optical interference is 2.4 nm or less.

In the magnetic recording medium, an average value A_{(E′)} of storage elastic moduli E′ in a temperature range of 60° C. to 65° C. when the dynamic mechanical analysis is performed may be 6 GPa or less.

In the magnetic recording medium, an average value A_{(Tanδ)} of Tanδs (loss elastic modulus E″/storage elastic modulus E′) in a temperature range of 60° C. to 65° C. when the dynamic mechanical analysis is performed may be 0.017 or less.

A base layer included in the magnetic recording medium may have an average thickness t_{Base} of 4.5 μm or less.

An average thickness t_{T} of the magnetic recording medium may be 5.3 μm or less.

A stiffness S of the magnetic recording medium may be 1.4 mgf/μm or less.

In the magnetic recording medium, the average value A_{(E″)} of loss elastic moduli E″ in a temperature range of 60° C. to 65° C. when the dynamic mechanical analysis is performed may be 0.05 GPa or less.

In the magnetic recording medium, the average value A_{(E″)} of loss elastic moduli E″ in a temperature range of 60° C. to 65° C. when the dynamic mechanical analysis is performed may be 0.04 GPa or less.

The average height Rpk of protruding peaks may be 2.3 nm or less.

The average height Rpk of protruding peaks may be 2.2 nm or less.

In the magnetic recording medium, an average value A_{(Tanδ)} of Tanδs when the dynamic mechanical analysis is performed is 0.016 or less.

In the magnetic recording medium, an average value A_{(Tanδ)} of Tanδs when the dynamic mechanical analysis is performed is 0.015 or less.

The magnetic recording medium may have a width variation ΔW₄₀ₕ when a weight of 0.55 N is applied in a longitudinal direction for 40 hours in an environment of a temperature of 65° C. and a humidity of 40% satisfies a relationship of −600 ppm≤ΔW₄₀ₕ.

The magnetic recording medium may include a magnetic layer that contains a magnetic powder.

The magnetic recording medium may be a vacuum thin-film recording medium.

Further, the present technology also provides a magnetic recording cartridge, including: the magnetic recording medium housed in a case while being wound around a reel.

### BRIEF DESCRIPTION OF DRAWINGS

FIG. 1 is a cross-sectional view showing a configuration of a magnetic recording medium according to a first embodiment.

FIG. 2 is an exploded perspective view showing an example of a configuration of a magnetic recording cartridge.

FIG. 3A is a diagram showing an example of a shape of a particle of a magnetic powder.

FIG. 3B shows an example of a TEM photograph of a sample cross section.

FIG. 3C shows another example of a TEM photograph of a sample cross section.

FIG. 4 is a diagram showing a measuring apparatus to be used for measuring a width variation ΔW₄₀ₕ.

FIG. 5 is a diagram for describing arrangement of five support members included in the measuring apparatus to be used for measuring the width variation ΔW₄₀ₕ.

FIG. 6 is a schematic diagram showing a configuration of a recording/reproduction apparatus.

FIG. 7 is a cross-sectional view showing a configuration of a magnetic recording medium according to a modified example.

FIG. 8 shows an example of a schematic cross-sectional view of a vacuum thin-film recording medium.

FIG. 9 is a diagram showing an example of a configuration of a sputtering apparatus to be used for producing a magnetic recording medium.

FIG. 10 shows an example of a schematic cross-sectional view of a vacuum thin-film recording medium.

FIG. 11 is a block diagram showing an example of a configuration of a cartridge memory.

FIG. 12 is an exploded perspective view showing an example of a configuration of a magnetic recording cartridge according to a modified example.

FIG. 13 is a diagram showing an example of a change in σsw, over time as a magnetic tape travels.

FIG. 14 is a diagram showing an example of a change in σsw, over time as a magnetic tape travels.

FIG. 15 is a diagram showing measurement results of a storage elastic modulus and a loss elastic modulus of a magnetic tape according to Example 1.

FIG. 16 is a diagram showing measurement results of Tanδ of the magnetic tape according to Example 1.

FIG. 17 is a diagram showing measurement results of width variations of magnetic tapes according to Example 1 and Comparative Example 3.

### MODE(S) FOR CARRYING OUT THE INVENTION

Hereinafter, suitable embodiments for carrying out the present technology will be described. Note that the embodiments described below show typical embodiments of the present technology, and the scope of the present technology is not limited only to these embodiments.

The present technology will be described in the following order.
1. Description of present technology
2. First embodiment (coating type magnetic recording medium)
(1) Configuration of magnetic recording medium
(2) Description of each layer
(3) Physical properties and structure
(4) Method of producing magnetic recording medium
(5) Recording/reproduction apparatus
(6) Modified example
3. Second embodiment (example of vacuum thin-film recording medium)
(1) Configuration of magnetic recording medium
(2) Description of each layer
(3) Physical properties and structure
(4) Configuration of sputtering apparatus
(5) Method of producing magnetic recording medium
(6) Modified example
(7) Another example of magnetic recording medium
4. Third Embodiment
(1) Embodiment of magnetic recording cartridge
(2) Modified example of magnetic recording cartridge
5. Example

In the present specification, unless a measurement environment is specifically stated regarding description of a measurement method, measurement is performed in an environment of 25° C.±2° C. and 50% RH±5% RH.

### 1. Description of Present Technology

As the demand for archives increase, tape storage with high total capacity is being incorporated into cloud systems. However, current tape storage systems have a narrower recommended temperature range of actual travelling and preservation than HDDs and semiconductor memories. For this reason, when incorporating a tape storage system into a cloud system, it is necessary to consider management of the temperature environment. This results in an increase in the energy required to maintain the environment of a data center of the cloud system, which is one of the obstacles when introducing tape storage into a data center. For example, in a tape library system in a data center, it is desired that a magnetic recording cartridge is preserved without adjusting the preservation environment of the magnetic recording cartridge that is not in recording or reproduction although the temperature of the drive travelling environment is adjusted to some extent, from the viewpoint of reducing power consumption or CO₂.

It is conceivable that by enabling a tape storage system to operate in temperature environments similar to those of HDDs, tape storage will become more widely used in data centers. HDDs are used in high-temperature environments in some cases, and preservation stability or travelling stability in such high-temperature environments has not been given much consideration regarding tape storage. In this regard, it is important to deal with shape deformation that can occur in high-temperature environments. Regarding the shape deformation, for example, when a magnetic tape is caused to travel by a drive, the magnetic tape is pulled longitudinally by the tension applied to the tape and becomes narrower in the width direction due to a creep phenomenon. It is conceivable to adjust the storage elastic modulus of the magnetic tape in order to deal with such shape deformation. For example, it is conceivable to use a base film having a high storage elastic modulus as a base layer of the magnetic tape.

Here, in order to realize tape storage having high total capacity, it is necessary to consider the fact that the capacity of cartridges is increasing. Specifically, the total thickness of the tape is desired to be very thin, e.g., 5.3 μm or less. Further, in order to improve the track density, the track width is also desired to be very thin, e.g., 1.5 μm or less. Further, it is also necessary to reduce the friction by ensuring proper contact between the tape and a head while improving the surface properties of the magnetic tape in order to reduce the spacing between the tape and the head.

Currently, negative pressure heads are commonly used as drive heads. In the case where a negative pressure head is used, in order to cause a magnetic tape having a high storage elastic modulus to properly come into contact with a recording and reproduction element on the head block, it is considered desirable to increase the negative pressure by increasing the approach angle of the magnetic tape and increase the head block width to ensure a sufficient length from the end portion of a head bar to the recording and reproduction element such that the magnetic tape properly comes into contact with the recording and reproduction element. However, particularly at high temperatures, increasing the contact pressure by increasing the negative pressure or increasing the contact area tends to lead to an increase in friction.

Further, it is conceivable to adopt a head block having a narrow head block width in order to reduce the contact area and use a magnetic tape having a small storage elastic modulus such that the magnetic tape properly comes into contact with the recording and reproduction element even in the case of adopting such a head block. However, the contact surface of a magnetic tape having a small storage elastic modulus tends to wear out when travelling in a high-temperature environment, which makes the tape travelling position easily shift (e.g., represented by an index σ_{sw}). Further, a magnetic tape having a small storage elastic modulus has a large width variation of the magnetic tape when preserved in a high-temperature environment, a track shift is more likely to occur during travelling after preservation in a high-temperature environment, and the possibility that the travelling stops also increases.

The present inventors have found that a specific magnetic recording medium is capable of improving preservation stability in a high-temperature environment and improving travelling stability after preservation in a high-temperature environment. Further, the present inventors have found that the specific magnetic recording medium is also capable of improving electromagnetic conversion characteristics.

More specifically, it has been found that by using a specific loss elastic modulus and a specific amount of surface protrusions of a magnetic layer, it is possible to reduce the amount of change in the tape width direction during travelling or preservation in a high-temperature environment and suppress an increase in friction during travelling. Further, the present technology also makes it possible to achieve these effects without increasing a storage elastic modulus.

That is, a magnetic recording medium according to the present technology has an average value A_{(E″)} of 0.06 GPa or less, which is of loss elastic moduli E″ in a temperature range of 60° C. to 65° C. when dynamic mechanical analysis is performed on the magnetic recording medium at a frequency of 10 Hz and a heating rate of 2° C./min and an average height Rpk of 2.4 nm or less, which is of protruding peaks measured using a non-contact profilometer using optical interference. By controlling the average value A_{(E″)} of loss elastic moduli E″ and the average height Rpk of protruding peaks in this way, it is possible to improve preservation stability in a high-temperature environment and improve travelling stability after preservation in a high-temperature environment. Further, it is possible to also improve electromagnetic conversion characteristics.

The magnetic recording medium according to the present technology may favorably be a long magnetic recording medium and may be, for example, a magnetic recording tape (particularly, a long magnetic recording tape).

The magnetic recording medium according to the present technology may include a magnetic layer, a non-magnetic layer (underlayer), a base layer, and a back layer in this order, and may include a different layer in addition to these layers. The different layer may be appropriately selected in accordance with the type of magnetic recording medium.

In one embodiment, the magnetic recording medium may be, for example, a coating type magnetic recording medium. That is, the magnetic recording medium may include a magnetic layer that contains a magnetic powder. The coating type magnetic recording medium will be described in detail in the following 2.

In another embodiment, the magnetic recording medium may be a vacuum thin-film recording medium. That is, the magnetic recording medium may be a sputter type magnetic recording medium. A vacuum thin-film recording medium will be described in detail in the following 3.

The magnetic recording medium according to the present technology may include, for example, at least one data band and at least two servo bands. The number of data bands is, for example, 2 to 10, particularly 3 to 6, more particularly 4 or 5. The number of servo bands is, for example, 3 to 11, particularly 4 to 7, more particularly 5 or 6. The servo band and the data band may be arranged, for example, so as to extend in the longitudinal direction of a long magnetic recording medium (particularly, a magnetic recording tape), particularly so as to be substantially parallel to each other. The data band and the servo band may be provided in the magnetic layer. Examples of the magnetic recording medium that includes a data band and a servo band include a magnetic recording tape conforming to the LTO (Linear Tape-Open) standard. That is, the magnetic recording medium may be a magnetic recording tape conforming to the LTO standard. For example, the magnetic recording medium may be a magnetic recording tape conforming to LTO9 or subsequent standards (e.g., LTO10, LTO11, or LTO12).

The width of the long magnetic recording medium (particularly, magnetic recording tape) is, for example, 5 mm to 30 mm, and may be particularly 7 mm to 25 mm, more particularly 10 mm to 20 mm, and still more particularly 11 mm to 19 mm. The length of the long magnetic recording medium (particularly, magnetic recording tape) may be, for example, 500 m to 1500 m. For example, the width of a tape conforming to the LTO9 standard is 12.65 mm, and the length thereof is 1035 m.

### 2. First Embodiment (Example of Coating Type Magnetic Recording Medium)

### (1) Configuration of Magnetic Recording Medium

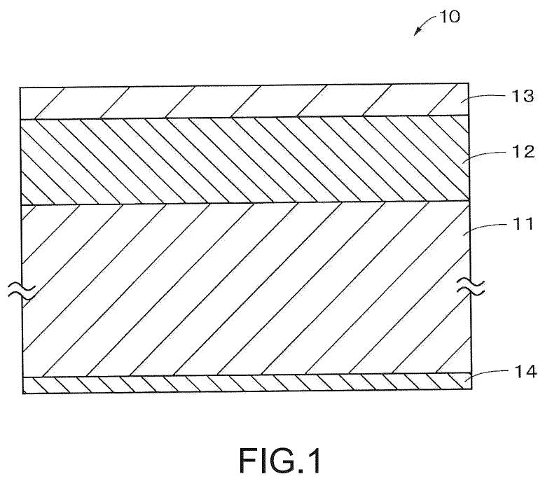

A configuration of a magnetic recording medium 10 according to a first embodiment will be described first with reference to FIG. 1. The magnetic recording medium 10 is, for example, a magnetic recording medium on which perpendicular orientation treatment has been performed. As shown in the figure, the magnetic recording medium 10 includes a long base layer (referred to also as a base) 11, an underlayer 12 provided on one main surface of the base layer 11, a magnetic layer (referred to also as a recording layer) 13 provided on the underlayer 12, and a back layer 14 provided on the other main surface of the base layer 11. Hereinafter, of both main surfaces of the magnetic recording medium 10, the surface on the side where the magnetic layer 13 is provided will be referred to as a magnetic surface, and the surface on the side opposite to the magnetic layer (surface where the back layer 14 is provided) will be referred to as a back surface.

The magnetic recording medium 10 has a long shape and is caused to travel in the longitudinal direction during recording and reproduction. Further, the magnetic recording medium 10 may be configured to be capable of recording a signal at a shortest recording wavelength of favorably 100 nm or less, more favorably 75 nm or less, still more favorably 60 nm or less, and particularly favorably 50 nm or less, and may be used in a recording/reproduction apparatus whose shortest recording wavelength is within the above range, for example. This recording/reproduction apparatus may include a ring-type head as a recording head. The recording track width is, for example, 2 μm or less.

### (2) Description of Each Layer

### (Base Layer)

The base layer 11 can function as a support for the magnetic recording medium 10, is, for example, a long non-magnetic base having flexibility, and may be particularly a non-magnetic film. An average thickness t_{Base} of the base layer 11 is, for example, 4.5 μm or less, favorably 4.2 μm or less, and may be more favorably 4.0 μm or less, 3.8 μm or less, or 3.6 μm or less, still more favorably 3.4 μm or less, 3.2 μm or less, or 3.0 μm or less. Note that the lower limit of the average thickness t_{Base} of the base layer 11 may be determined from the viewpoint of, for example, the film deposition limit, the function of the base layer 11, and the like, and may be, for example, 2.0 μm or more, 2.2 μm or more, 2.4 μm or more, or 2.6 μm or more. The base layer 11 may contain, for example, at least one of a polyester resin, a polyolefin resin, a cellulose derivative, a vinyl resin, an aromatic polyetherketone resin, or another polymer resin. In the case where the base layer 11 contains two or more of the above materials, the two or more materials may be mixed, copolymerized, or stacked.

The polyester resin may be, for example, one of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p-oxybenzoate), and polyethylene bisphenoxycarboxylate, or a mixture of two or more thereof.

The polyolefin resin may be, for example, one of PE (polyethylene) and PP (polypropylene), or a mixture of two or more thereof.

The cellulose derivative may be, for example, one of cellulose diacetate, cellulose triacetate, CAB (cellulose acetate butyrate), and CAP (cellulose acetate propionate), or a mixture of two or more thereof.

The vinyl resin may be, for example, one of PVC (polyvinyl chloride) and PVDC (polyvinylidene chloride), or a mixture of two or more thereof.

The aromatic polyetherketone resin may be, for example, one of PEK (polyetherketone), PEEK (polyetheretherketone), PEKK (polyetherketoneketone), and PEEKK (polyetheretherketoneketone), or a mixture of two or more thereof. In accordance with a favorable embodiment of the present technology, the base layer 11 may be formed of an aromatic polyetherketone resin, and may be formed of, for example, PEEK. An average value of loss elastic moduli of the aromatic polyetherketone resin can be easily adjusted to the numerical range described below.

The different polymer resin may be, for example, one of PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, e.g., Zylon (registered trademark), polyether, polyetherester, PES (polyethersulfone), PEI (polyetherimide), PSF (polysulfone), PPS (polyphenylene sulfide), PC (polycarbonate), PAR (polyarylate), and PU (polyurethane), or a mixture of two or more thereof.

### (Magnetic Layer)

The magnetic layer 13 may be, for example, a perpendicular recording layer. The magnetic layer 13 includes a magnetic powder. The magnetic layer 13 may further include a binder. The magnetic layer 13 may further include non-magnetic particles. The magnetic layer 13 may further include an additive such as a lubricant and a rust inhibitor as necessary.

An average thickness tₘ of the magnetic layer 13 may be favorably 80 nm or less, more favorably 70 nm or less, still more favorably 60 nm or less, 50 nm or less, and even more favorably 40 nm or less. The lower limit value of the average thickness tₘ of the magnetic layer is not particularly limited, but may favorably be 30 nm or more. The average thickness tₘ of the magnetic layer 13 within the above numerical range contributes to improving the electromagnetic conversion characteristics.

The magnetic layer 13 is favorably a perpendicularly oriented magnetic layer. In the present specification, the term “perpendicularly oriented” means that a squareness ratio Si measured in the longitudinal direction of the magnetic recording medium 10 (travelling direction) is 35% or less.

Note that the magnetic layer 13 may be an in-plane oriented (longitudinally oriented) magnetic layer. That is, the magnetic recording medium 10 may be a longitudinal recording magnetic recording medium. However, from the viewpoint of achieving high recording density, it is more favorably perpendicularly oriented.

### (Magnetic Powder)

Examples of magnetic particles forming the magnetic powder contained in the magnetic layer 13 include, but are not limited to, hexagonal ferrite, epsilon-type iron oxide (ε-iron oxide), Co-containing spinel ferrite, gamma hematite, magnetite, chromium dioxide, cobalt-coated iron oxide, and metal. The above magnetic powder may be one of these or a combination of two or more of them. Favorably, the above magnetic powder may include hexagonal ferrite, ε-iron oxide, or Co-containing spinel ferrite. Particularly favorably, the above magnetic powder is hexagonal ferrite. The above hexagonal ferrite may include particularly favorably at least one of Ba or Sr. The ε-iron oxide may include particularly favorably at least one of Al or Ga. These magnetic particles may be appropriately selected by those skilled in the art on the basis of factors such as the method of producing the magnetic layer 13, the standard of the tape, and the function of the tape.

The shape of the magnetic particles depends on the crystal structure of the magnetic particles. For example, barium ferrite (BaFe) and strontium ferrite may have a hexagonal plate shape. ε-iron oxide may be spherical. Cobalt ferrite may be cubic. The metal may be spindle-shaped. These magnetic particles are oriented in the process of producing the magnetic recording medium 10.

The average particle size of the magnetic powder may be favorably 50 nm or less, more favorably 40 nm or less, and still more favorably 30 nm or less, 25 nm or less, 22 nm or less, 21 nm or less, or 20 nm or less. The above average particle size may be, for example, 10 nm or more, favorably 12 nm or more.

The average aspect ratio of the magnetic powder may be, for example, 1.0 or more and 3.0 or less, and may be 1.0 or more and 2.9 or less.

(Embodiment in which Magnetic Powder Contains Hexagonal Ferrite)

In accordance with a favorable embodiment of the present technology, the magnetic powder contains hexagonal ferrite, and may more particularly include a powder of nanoparticles containing hexagonal ferrite (hereinafter, referred to as “hexagonal ferrite particles”). Hexagonal ferrite is favorably hexagonal ferrite having an M-type structure. Hexagonal ferrite has, for example, a hexagonal plate shape or a substantially hexagonal plate shape. Hexagonal ferrite may contain favorably at least one of Ba, Sr, Pb, or Ca, more favorably at least one of Ba, Sr, or Ca. Hexagonal ferrite may specifically be, for example, one selected from the group consisting of barium ferrite, strontium ferrite, and calcium ferrite, or a combination of two or more of them, and is particularly favorably barium ferrite or strontium ferrite. Barium ferrite may further contain at least one of Sr, Pb, or Ca in addition to Ba. Strontium ferrite may further contain at least one of Ba, Pb, or Ca in addition to Sr.

More specifically, hexagonal ferrite may have an average composition represented by the general formula MFe₁₂O₁₉. Here, M is, for example, at least one metal of Ba, Sr, Pb, or Ca, favorably at least one metal of Ba or Sr. M may be a combination of Ba and one or more metals selected from the group consisting of Sr, Pb, and Ca. Further, M may be a combination of Sr and one or more metals selected from the group consisting of Ba, Pb, and Ca. In the above general formula, some Fes may be substituted by another metal element.

In the case where the magnetic powder includes a powder of hexagonal ferrite particles, the average particle size of the magnetic powder may be favorably 50 nm or less, more favorably 40 nm or less, and still more favorably 30 nm or less, 25 nm or less, 22 nm or less, 21 nm or less, or 20 nm or less. The above average particle size may be, for example, 10 nm or more, favorably 12 nm or more, and more favorably 15 nm or more. For example, the average particle size of the above magnetic powder may be 10 nm or more and 50 nm or less, 10 nm or more and 40 nm or less, 12 nm or more and 30 nm or less, 12 nm or more and 25 nm or less, or 15 nm or more and 22 nm or less. In the case where the average particle size of the magnetic powder is less than or equal to the above upper limit value (e.g., 50 nm or less, particularly 30 nm or less), favorable electromagnetic conversion characteristics (e.g., SNR) can be obtained in the magnetic recording medium 10 having high recording density. In the case where the average particle size of the magnetic powder is not less than the above lower limit value (e.g., 10 nm or more, favorably 12 nm or more), the dispersibility of the magnetic powder is further improved, and more excellent electromagnetic conversion characteristics (e.g., SNR) can be obtained.

In the case where the magnetic powder includes a powder of hexagonal ferrite particles, the average aspect ratio of the magnetic powder may be favorably 1.0 or more and 3.0 or less, more favorably 1.0 or more and 2.9 or less, and still more favorably 2.0 or more and 2.9 or less. When the average aspect ratio of the magnetic powder is within the above numerical range, it is possible to suppress aggregation of the magnetic powder and suppress the resistance applied to the magnetic powder at the time when causing the magnetic powder to be perpendicularly oriented in the process of forming the magnetic layer 13. This may result in improvement in the perpendicular orientation of the magnetic powder.

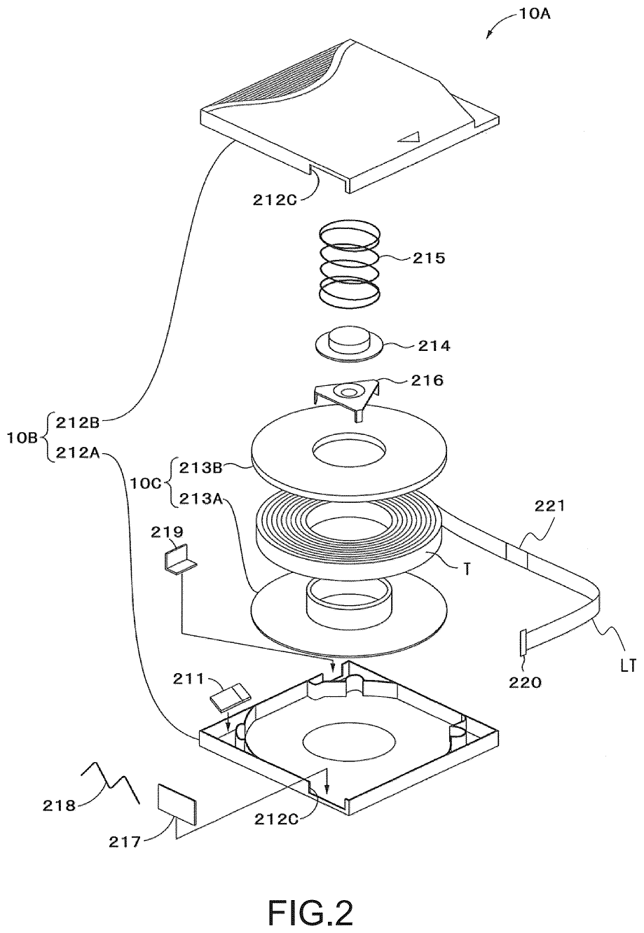

In the case where the magnetic powder includes a powder of hexagonal ferrite particles, the average particle size and the average aspect ratio of the magnetic powder are obtained as follows. First, a magnetic recording medium (hereinafter, referred to also as a “magnetic tape”) housed in a magnetic recording cartridge is unwound, and approximately 50 mm of the magnetic tape to be measured is cut out. The cut out-position may be a position 30 m in the longitudinal direction from a connection part 221 between a magnetic tape T (magnetic recording medium 10) and a leader tape LT in the case of a magnetic recording cartridge 10A as shown in FIG. 2 described below, for example. Subsequently, the magnetic tape to be measured is processed by an FIB method or the like to obtain a slice. In the case of using the FIB method, a carbon layer and a tungsten layer are formed as protective films as pre-processing for observing a TEM image of a cross section described below. The carbon layer is formed on the surface on the side of the magnetic layer and the surface on the side of the back layer of the magnetic tape by a vapor deposition method, and the tungsten layer is further formed on the surface on the side of the magnetic layer by a vapor deposition method or a sputtering method. The slicing is performed along the length direction (longitudinal direction) of the magnetic tape. That is, the slicing forms a cross section parallel to both the longitudinal direction and the thickness direction of the magnetic tape.

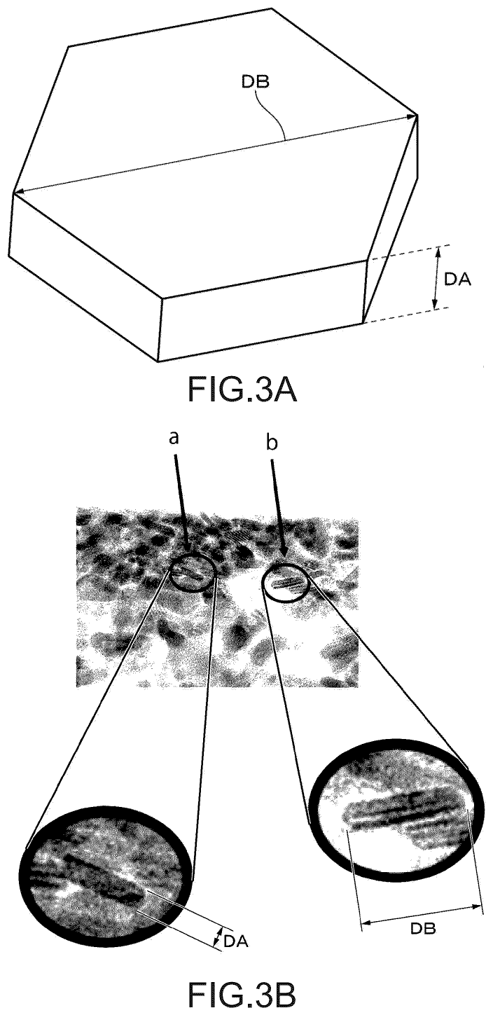

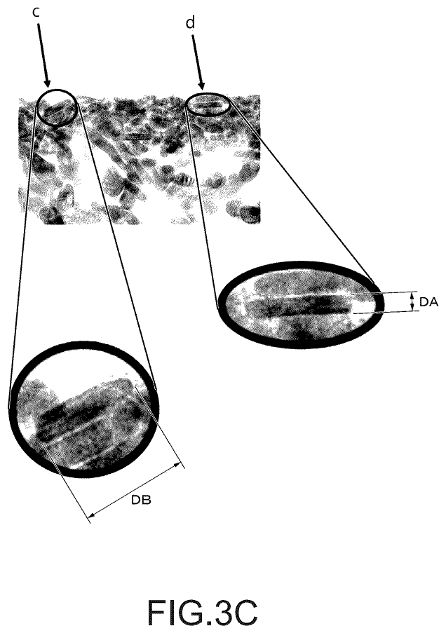

The above cross section of the obtained slice sample is observed using a transmission electron microscope (H-9500 manufactured by Hitachi High-Technologies Corporation) at an acceleration voltage: 200 kV and a total magnification of 500,000 times such that the entire magnetic layer is included in the thickness direction of the magnetic layer to take a TEM photograph. The number of TEM photographs to be prepared is such that 50 particles from which a plate diameter DB and a plate thickness DA (see FIG. 3A) shown below can be measured can be extracted.

In the present specification, regarding the size of hexagonal ferrite particles (hereinafter, referred to as a “particle size”), in the case where the shape of a particle observed in the above TEM photograph is a plate shape or a columnar shape (however, the thickness or height is smaller than the long diameter of the plate surface or bottom surface.) as shown in FIG. 3A, the long diameter of the plate surface or bottom surface is used as the value of the plate diameter DB. The thickness or height of the particle observed in the above TEM photograph is used as the value of the plate thickness DA. In the case where the plate surface or bottom surface of the particle observed in the TEM photograph has a hexagonal shape, the long diameter means the longest diagonal distance. In the case where the thickness or height of the particle in one particle is not constant, the thickness or height of the maximum particle is used as the plate thickness DA.

Next, 50 particles to be extracted from the taken TEM photograph are selected on the basis of the following criteria. Particles that partially protrude outside the field of view of the TEM photograph are not measured, and isolated particles with clear outlines are measured. In the case where particles overlap with each other, each particle is measured as a single particle if the boundary between them is clear and the shape of the entire particle can be determined. However, particles with an unclear boundary and whose entire shape cannot be determined are not measured as the shape of the particle cannot be determined.

FIG. 3B and FIG. 3C each show an example of the TEM photograph. In these figures, for example, particles indicated by arrows a and d are selected because the plate thickness (thickness or height of the particle) DA of the particle can be clearly checked. The plate thickness DA of each of the 50 selected particles is measured. The plate thicknesses DA obtained in this way are simply averaged (arithmetically averaged) to obtain an average plate thickness DAₐᵥₑ. The average plate thickness DAₐᵥₑ is the average particle plate thickness. Subsequently, the plate diameter DB of each of the magnetic powders is measured. In order to measure the plate diameter DB of the particle, 50 particles whose plate diameter DB can be clearly checked are selected from the taken TEM photograph. For example, particles indicated by arrows b and c in these figures are selected because the plate diameter DB thereof can be clearly checked. The plate diameter DB of each of the 50 selected particles is measured. The plate diameters DB obtained in this way are simply averaged (arithmetically averaged) to obtain an average plate diameter DBₐᵥₑ. The average plate diameter DBₐᵥₑ is the average particle size.

In the case where the magnetic powder includes a powder of hexagonal ferrite particles, the average particle volume of the magnetic powder is favorably 1800 nm³ or less, more favorably 1600 nm³ or less, more favorably 1400 nm³ or less, and may be still more favorably 1200 nm³ or less, 1100 nm³ or less, or 1000 nm³ or less. The average particle volume of the magnetic powder may be favorably 500 nm³ or more, more favorably 700 nm³ or more.

In the case where the average particle volume of the magnetic powder is less than or equal to the above upper limit value (e.g., 2,000 nm³ or less), favorable electromagnetic conversion characteristics (e.g., SNR) can be obtained in the magnetic recording medium 10 having high recording density. In the case where the average particle volume of the magnetic powder is greater than or equal to the above lower limit value (e.g., 500 nm³ or more), the dispersibility of the magnetic powder is further improved, and more excellent electromagnetic conversion characteristics (e.g., SNR) can be obtained.

The average particle volume of the magnetic powder is obtained as follows. First, the average plate thickness DAₐᵥₑ and the average plate diameter DBₐᵥₑ are obtained as described regarding the above method of Calculating the average particle size of the magnetic powder. Next, an average particle volume V of the magnetic powder is obtained by the following formula.

$$V = \frac{3 \sqrt{3}}{8} \times {DA}_{a v e} \times {DB}_{ave} \times {DB}_{a v e} \qquad [ Math . 1 ]$$

In accordance with a particularly favorable embodiment of the present technology, the above magnetic powder is a barium ferrite magnetic powder or a strontium ferrite magnetic powder, and may be more favorably a barium ferrite magnetic powder. The barium ferrite magnetic powder includes magnetic particles of iron oxide having barium ferrite as a main phase (hereinafter, referred to as “barium ferrite particles”). The barium ferrite magnetic powder is highly reliable in recording data, e.g., the coercive force of the barium ferrite magnetic powder does not drop even in high-temperature and high-humidity environments. From such a point of view, a barium ferrite magnetic powder is favorable as the above magnetic powder.

The average particle size of the barium ferrite magnetic powder is 22 nm or less, more favorably 10 nm or more and 20 nm or less, and still more favorably 12 nm or more and 18 nm or less.

In the case where the magnetic layer 13 includes a barium ferrite magnetic powder as a magnetic powder, the average thickness tₘ [nm] of the magnetic layer 13 is favorably 90 nm or less, more favorably 80 nm or less. For example, the average thickness tₘ of the magnetic layer 13 may satisfy the relationship of 35 nm≤tₘ≤90 nm or 35 nm≤tₘ≤80 nm.

Further, a coercive force Hc1 measured in the thickness direction (perpendicular direction) of the magnetic recording medium 10 is favorably 2,010 [Oe] or more and 3,520 [Oe] or less, more favorably 2,070 [Oe] or more and 3,460 [Oe] or less, and still more favorably 2,140 [Oe] or more and 3,390 [Oe] or less.

(Embodiment in which Magnetic Powder Contains ε-Iron Oxide)

In accordance with another favorable embodiment of the present technology, the above magnetic powder may favorably include a powder of nanoparticles containing ε-iron oxide (hereinafter, referred to as “ε-iron oxide particles”.). The ε-iron oxide particle may have a composite particle structure. More specifically, the ε-iron oxide particle includes an ε-iron oxide part and a part that has soft magnetism or a part that has magnetism having a saturation magnetization amount σs higher than that of ε-iron oxide and a coercive force Hc smaller than that of ε-iron oxide (hereinafter, referred to as a “part that has soft magnetic, or the like”.).

The ε-iron oxide part contains ε-iron oxide. The ε-iron oxide contained in the ε-iron oxide part favorably has ε—Fe₂O₃ crystal as a main phase and is more favorably formed of single-phase ε—Fe₂O₃.

The part that has soft magnetic, or the like is at least partially in contact with the ε-iron oxide part. Specifically, the part that has soft magnetic, or the like may partially cover the ε-iron oxide part or may cover the entire periphery of the ε-iron oxide part.

The part that has soft magnetism (part that has magnetism having a saturation magnetization amount σs higher than that of ε-iron oxide and a coercive force Hc smaller than that of ε-iron oxide) contains, for example, a soft magnetic material such as α-Fe, a Ni—Fe alloy, and an Fe—Si—Al alloy. α-Fe may be obtained by reducing ε-iron oxide contained in the ε-iron oxide part.

Further, the part that has soft magnetism may contain, for example, Fe₃O₄, γ-Fe₂O₃, or spinel ferrite.

When the ε-iron oxide particle includes the part that has soft magnetic, or the like as described above, it is possible to adjust the coercive force Hc of the entire ε-iron oxide particle (composite particle) to the coercive force Hc suitable for recording while keeping the coercive force Hc of the ε-iron oxide part alone at a large value in order to ensure thermal stability.

The ε-iron oxide particle may include an additive instead of the above composite particle structure, or may include an additive in addition to the above composite particle structure. In this case, some Fes of the ε-iron oxide particle are substituted by the additive. Also with the ε-iron oxide particle including the additive, the coercive force Hc of the entire ε-iron oxide particle can be adjusted to the coercive force Hc suitable for recording, and thus, it is possible to improve the easiness of recording. The additive is a metal element other than iron, favorably a trivalent metal element, more favorably at least one selected from the group consisting of Al, Ga, and In, and still more favorably at least one selected from the group consisting of Al and Ga.

Specifically, the ε-iron oxide including an additive is an ε—Fe₂₋ₓMₓO₃ crystal (however, M is a metal element other than iron, favorably a trivalent metal element, more favorably at least one selected from the group consisting of Al, Ga, and In, and still more favorably at least one selected from the group consisting of Al and Ga. x satisfies, for example, the relationship of 0<x<1.).

The average particle size (average maximum particle size) of the magnetic powder is favorably 22 nm or less, more favorably 8 nm or more and 22 nm or less, and still more favorably 12 nm or more and 22 nm or less. In the magnetic recording medium 10, the region that is half the size of the recording wavelength is the actual magnetization region. For this reason, by setting the average particle size of the magnetic powder to half or less of the shortest recording wavelength, it is possible to obtain a favorable SNR. Therefore, when the average particle size of the magnetic powder is 22 nm or less, favorable electromagnetic conversion characteristics (e.g., SNR) can be obtained in the magnetic recording medium 10 having high recording density (e.g., the magnetic recording medium 10 configured to be capable of recording signals at the shortest recording wavelength of 44 nm or less). Meanwhile, in the case where the average particle size of the magnetic powder is 8 nm or more, the dispersibility of the magnetic powder is further improved, and more excellent electromagnetic conversion characteristics (e.g., SNR) can be obtained.

The average aspect ratio of the magnetic powder is favorably 1.0 or more and 3.0 or less, more favorably 1.0 or more and 2.9 or less, and still more favorably 1.0 or more and 2.5 or less. When the average aspect ratio of the magnetic powder is within the above numerical range, it is possible to suppress aggregation of the magnetic powder and suppress the resistance applied to the magnetic powder at the time when causing the magnetic powder to be perpendicularly oriented in the process of forming the magnetic layer 13. Therefore, it is possible to improve the perpendicular orientation of the magnetic powder.

In the case where the magnetic powder includes ε-iron oxide particles, the average particle size and the average aspect ratio of the magnetic powder are obtained as follows. First, a magnetic recording medium to be measured is cut out as described regarding the case where the magnetic powder includes a powder of hexagonal ferrite particles. The magnetic recording medium to be measured is processed by the FIB (Focused Ion Beam) method or the like to obtain a slice. In the case of using the FIB method, a carbon film and a tungsten thin film are formed as protective films as pre-processing for observing a TEM image of a cross section described below. The carbon film is formed on the surface on the side of the magnetic layer and the surface on the side of the back layer of the magnetic recording medium by a vapor deposition method, and the tungsten thin film is further formed on the surface on the side of the magnetic layer by a vapor deposition method or a sputtering method. The slicing is performed along the length direction (longitudinal direction) of the magnetic recording medium. That is, the slicing forms a cross section parallel to both the longitudinal direction and the thickness direction of the magnetic recording medium.

The above cross section of the obtained slice sample is observed using a transmission electron microscope (H-9500 manufactured by Hitachi High-Technologies Corporation) at an acceleration voltage: 200 kV and a total magnification of 500,000 times such that the entire magnetic layer 13 is included with respect to the thickness direction of the magnetic layer 13 to take a TEM photograph.

Next, 50 particles, which have the shape that can be clearly checked, are selected from the taken TEM photograph, and a major axis length DL and a minor axis length DS of each particle are measured. Here, the major axis length DL means the largest one (so-called maximum Feret diameter) of the distances between two parallel lines drawn from all angles so as to be in contact with the contour of the particle. Meanwhile, the minor axis length DS means the largest one of the lengths of the particles in the direction perpendicular to the major axis (DL) of the particle.

Subsequently, the measured major axis lengths DL of the 50 particles are simply averaged (arithmetically averaged) to obtain an average major axis length DLₐᵥₑ. The average major axis length DLₐᵥₑ obtained in this way is used as the average particle size of the magnetic powder. Further, the measured minor axis lengths DS of the 50 particles are simply averaged (arithmetically averaged) to obtain an average minor axis length DSₐᵥₑ. Then, the average aspect ratio (DLₐᵥₑ/DSₐᵥₑ₎ of the particles is obtained from the average major axis length DLₐᵥₑ and the average minor axis length DSₐᵥₑ.

The average particle volume of the magnetic powder is favorably 1,800 nm³ or less, more favorably 1,600 nm³ or less, more favorably 1,400 nm³ or less, and may be still more favorably 1,200 nm³ or less, 1,100 nm³ or less, or 1,000 nm³ or less. The average particle volume of the magnetic powder may be favorably 500 nm³ or more, more favorably 700 nm³ or more.

In the case where the average particle volume of the magnetic powder is less than or equal to the above upper limit value (e.g., 2,000 nm³ or less), favorable electromagnetic conversion characteristics (e.g., SNR) can be obtained in the magnetic recording medium 10 having high recording density. In the case where the average particle volume of the magnetic powder is greater than or equal to the above lower limit value (e.g., 500 nm³ or more), the dispersibility of the magnetic powder is further improved, and more excellent electromagnetic conversion characteristics (e.g., SNR) can be obtained.

In the case where the ε-iron oxide particle has a spherical shape or a substantially spherical shape, the average particle volume of the magnetic powder is obtained as follows. First, the average major axis length DLₐᵥₑ is obtained in the same manner as the above method of calculating the average particle size of the magnetic powder. Next, the average particle volume V of the magnetic powder is obtained by the following formula.

$$V = ( π / 6 ) \times {DL}_{ave}^{3}$$

In the case where the ε-iron oxide particle has a cubic shape, the average particle volume of the magnetic powder is obtained as follows. The magnetic recording medium 10 is processed by the FIB (Focused Ion Beam) method or the like to obtain a slice. In the case of using the FIB method, a carbon film and a tungsten thin film are formed as protective films as pre-processing for observing a TEM image of a cross section described below. The carbon film is formed on the surface on the side of the magnetic layer and the surface on the side of the back layer of the magnetic recording medium 10 by a vapor deposition method, and the tungsten thin film is further formed on the surface on the side of the magnetic layer by a vapor deposition method or a sputtering method. The slicing is performed along the length direction (longitudinal direction) of the magnetic recording medium 10. That is, the slicing forms a cross section parallel to both the longitudinal direction and the thickness direction of the magnetic recording medium 10.

The cross section of the obtained slice sample is observed using a transmission electron microscope (H-9500 manufactured by Hitachi High-Technologies Corporation) at an acceleration voltage: 200 kV and a total magnification of 500,000 times such that the entire magnetic layer 13 is included with respect to the thickness direction of the magnetic layer 13 to obtain a TEM photograph. Note that the magnification and acceleration voltage may be appropriately adjusted in accordance with the type of apparatus.

Next, 50 particles whose shapes can be clearly observed are selected from the taken TEM photograph, and a side length DC of each particle is measured. Subsequently, the measured side lengths DC of the 50 particles are simply averaged (arithmetically averaged) to obtain an average side length DCₐᵥₑ. Next, the average side length DCₐᵥₑ is used to calculate an average particle volume Vₐᵥₑ (particle volume) of the magnetic powder from the following formula.

$${V}_{a v e} = {DC}_{ave}^{3}$$

The coercive force Hc of the ε-iron oxide particles is favorably 2,500 Oe or more, more favorably 2,800 Oe or more and 4,200 Oe or less.

(Embodiment in which Magnetic Powder Contains Co-Containing Spinel Ferrite)

In accordance with a still another favorable embodiment of the present technology, the magnetic powder may include a powder of nanoparticles containing Co-containing spinel ferrite (hereinafter, referred to also as “cobalt ferrite particles”). That is, the magnetic powder may be a cobalt ferrite magnetic powder. It is favorable that the cobalt ferrite particle has uniaxial crystal anisotropy. The cobalt ferrite magnetic particle has, for example, a cubic shape or a substantially cubic shape. The Co-containing spinel ferrite may further contain, in addition to Co, one or more selected from the group consisting of Ni, Mn, Al, Cu, and Zn.

Cobalt ferrite has, for example, an average composition represented by the following formula.

CoₓM_{y}Fe₂O_{z}
(however, in the above formula, M represents, for example, one or more metals selected from the group consisting of Ni, Mn, Al, Cu, and Zn. x represents a value within the range of 0.4≤x≤1.0. y represents a value within the range of 0≤y≤0.3. However, x and y satisfy the relationship of (x+y)≤1.0. z represents a value within the range of 3≤z≤4. Some Fes may be substituted with another metal element.)

The average particle size of the cobalt ferrite magnetic powder is favorably 21 nm or less, more favorably 19 nm or less. The coercive force Hc of the cobalt ferrite magnetic powder is favorably 2500 Oe or more, more favorably 2600 Oe or more and 3500 Oe or less.

In the case where the magnetic powder includes a powder of cobalt ferrite particles, the average particle size of the magnetic powder is favorably 25 nm or less, more favorably 10 nm or more and 19 nm or less. When the average particle size of the magnetic powder is small like this, favorable electromagnetic conversion characteristics (e.g., SNR) can be obtained in the magnetic recording medium 10 having high recording density. Meanwhile, when the average particle size of the magnetic powder is 10 nm or more, the dispersibility of the magnetic powder is further improved, and more excellent electromagnetic conversion characteristics (e.g., SNR) can be obtained. In the case where the magnetic powder includes a powder of cobalt ferrite particles, the average aspect ratio and average particle size of the magnetic powder are obtained in the same manner as that in the case where the magnetic powder contains ε-iron oxide particles.

The average particle volume of the magnetic powder is favorably 2,000 nm³ or less, more favorably 1,900 nm³ or less, more favorably 1,800 nm³ or less, and may be still more favorably 1,700 nm³ or less, 1,600 nm³ or less, or 1,500 nm³ or less. The average particle volume of the magnetic powder may be favorably 500 nm³ or more, more favorably 700 nm³ or more.

In the case where the average particle volume of the magnetic powder is less than or equal to the above upper limit value (e.g., 2,000 nm³ or less), favorable electromagnetic conversion characteristics (e.g., SNR) can be obtained in the magnetic recording medium 10 having high recording density. In the case where the average particle volume of the magnetic powder is greater than or equal to the above lower limit value (e.g., 500 nm³ or more), the dispersibility of the magnetic powder is further improved, and more excellent electromagnetic conversion characteristics (e.g., SNR) can be obtained.

### (Binder)

As the binder, a resin having a structure obtained by imparting a crosslinking reaction to a polyurethane resin, a vinyl chloride resin, or the like is favorable. However, the binder is not limited to these, and another resin may be appropriately blended in accordance with the physical properties required for the magnetic recording medium 10. The resin to be blended is not particularly limited as long as it is a resin commonly used in the coating type the magnetic recording medium 10.

Examples of the binder include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, nitrocellulose), a styrene butadiene copolymer, a polyester resin, an amino resin, and synthetic rubber.

Further, as the binder, a thermosetting resin or a reactive resin may be used. Examples thereof include a phenolic resin, an epoxy resin, a urea resin, a melamine resin, an alkyd resin, a silicone resin, a polyamine resin, and a urea formaldehyde resin.

Further, a polar functional group such as —SO₃M, —OSO₃M, —COOM, P═O(OM)₂ may be introduced into each of the above-mentioned binders for the purpose of improving dispersibility of the magnetic powder. Here, in the formula, M represents a hydrogen atom, or an alkali metal such as lithium, potassium, and sodium.

Further, examples of the polar functional group include a side chain type one having a terminal group of —NR1R2 or —NR1R2R3⁺X⁻, and a main chain type one having >NR1R2⁺X⁻. Here, in the formula, R1, R2, and R3 each represent a hydrogen atom or a hydrocarbon group, and X⁻ represents a halogen element ion such as fluorine, chlorine, bromine, and iodine, or an inorganic or organic ion. Further, examples of the polar functional group include —OH, —SH, —CN, and an epoxy group.

### (Lubricant)

The magnetic layer may include a lubricant. The lubricant may be, for example, one or two or more selected from a fatty acid and/or a fatty acid ester, and may favorably include both a fatty acid and a fatty acid ester. The fatty acid may favorably be a compound represented by the following general chemical formula (1) or general chemical formula (2). For example, as the fatty acid, one or both of the compound represented by the following general chemical formula (1) and the compound represented by the general chemical formula (2) may be included.

Further, the fatty acid ester may favorably be a compound represented by the following general chemical formula (3), a compound represented by the general chemical formula (4), or a compound represented by the general chemical formula (5). For example, as the fatty acid ester, one, two, or all three of the compound represented by the following general chemical formula (3), the compound represented by the general chemical formula (4), and the compound represented by the general chemical formula (5) may be included.

When the lubricant includes one or both of the compound represented by the general chemical formula (1) and the compound represented by the general chemical formula (2), and one, two, or three of the compound represented by the general chemical formula (3), the compound represented by the general chemical formula (4), and the compound represented by the general chemical formula (5), it is possible to suppress an increase in the dynamic friction coefficient due to repeated recording or reproduction of the magnetic recording medium.

CH₃(CH₂)ₖCOOH (1)
(however, in the general chemical formula (1), k represents an integer selected from the range of 14 or more and 22 or less, more favorably the range of 14 or more and 18 or less.)

CH₃(CH₂)ₙCH═CH(CH₂)ₘCOOH (2)
(however, in the general chemical formula (2), the sum of n and m represents an integer selected from the range of 12 or more and 20 or less, more favorably 14 or more and 18 or less.)

CH₃(CH₂)ₚCOO(CH₂)_{q}CH₃ (3)
(however, in the general chemical formula (3), p represents an integer selected from the range of 14 or more and 22 or less, more favorably 14 or more and 18 or less, and q represents an integer selected from the range of 2 or more and 5 or less, more favorably 2 or more and 4 or less.)

CH₃(CH₂)ᵣCOO—(CH₂)ₛCH(CH₃)₂ (4)
(however, in the general chemical formula (4), r represents an integer selected from the range of 14 or more and 22 or less, and s represents an integer selected from the range of 1 or more and 3 or less.)

CH₃(CH₂)ₜCOO—(CH)(CH₃₎CH₂(CH₃)ᵤ (5)
(however, in the general formula (5), t represents an integer selected from the range of 14 or more and 22 or less, and u represents an integer selected from the range of 1 or more and 3 or less.)

Examples of the lubricant include esters of monobasic fatty acids having 10 to 24 carbon atoms and any of monovalent to hexavalent alcohols having 2 to 12 carbon atoms, mixed esters thereof, difatty acid esters, and trifatty acid esters. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, and octyl myristate. The magnetic layer may contain one or two or more of these.

The content of the lubricant may be, for example, 1 part by mass or more, favorably 2 parts by mass or more with respect to 100 parts by mass of the magnetic powder. Further, the content may be, for example, 10 parts by mass or less, favorably 8 parts by mass or less, and more favorably 6 parts by mass or less with respect to 100 parts by mass of the magnetic powder.

### (Additive)

The magnetic layer 13 may further contain, as non-magnetic reinforcing particles, aluminum oxide (α, β, or γ alumina), chromium oxide, silicon oxide, diamond, garnet, emery, boron nitride, titanium carbide, silicon carbide, titanium carbide, titanium oxide (rutile-type or anatase-type titanium oxide), or the like.

In an embodiment of the present technology, the magnetic layer may include first particles having conductivity and second particles having a Mohs hardness of 7 or more. The first particles and the second particles may form protrusions on the surface on the side of the magnetic layer. For example, the first particles make it possible to prevent an increase in frictional force during travelling of the magnetic recording tape and function as, for example, a solid lubricant component. Further, the second particles make it possible to exhibit a polishing effect (and even an anchor effect) for cleaning the magnetic head. It is conceivable that by containing these two components in the magnetic layer of the magnetic recording tape, an increase in frictional force is prevented and the magnetic head is cleaned, thereby improving the travelling performance.

By adjusting the type and/or content of non-magnetic reinforcing particle, the average height Rpk of protruding peaks described below can be adjusted.

The first particles have conductivity. As the first particles, fine particles containing carbon as a main component can be used. For example, carbon particles may favorably be used. Examples of such carbon particles include carbon black. As the carbon black, for example, Asahi #15 and Asahi #15HS manufactured by ASAHI CARBON CO., LTD. or SEAST TA manufactured by Tokai Carbon Co., Ltd. can be used. Further, hybrid carbon in which carbon is attached to the surface of silica particles may be used.

The average particle size(arithmetic mean value of particle diameters measured using electron microscopy) of the first particles (particularly, carbon particles, e.g., carbon black) may be, for example, 15 nm or more, favorably 30 nm or more, and more favorably 50 nm or more. Further, the average particle size may be, for example, 200 nm or less, favorably 180 nm or less, and more favorably 150 nm or less, 130 nm or less, or 120 nm or less. The numerical range of the average particle size may be appropriately selected from these upper limit value and lower limit value, and may be, for example, 50 nm to 200 nm, favorably 50 nm to 180 nm, more favorably 50 nm to 150 nm, and still more favorably 50 nm to 130 nm.

The nitrogen absorption specific surface area of the first particles (particularly, carbon particles, e.g., carbon black) may be, for example, 5 m²/g to 50 m²/g, favorably 7 m²/g to 50 m²/g, more favorably 10 m²/g to 50 m²/g, and still more favorably 12 m²/g to 50 m²/g.

The iodine adsorption amount of the first particles (particularly, carbon particles, e.g., carbon black) may be, for example, 5 mg/g to 50 mg/g, favorably 7 mg/g to 50 mg/g, more favorably 10 mg/g to 50 mg/g, and still more favorably 12 mg/g to 50 mg/g.

The second particles may have a Mohs hardness of 7 or more, favorably 7.5 or more, more favorably 8 or more, and still more favorably 8.5 or more from the viewpoint of suppressing deformation due to contact with the magnetic head. From the viewpoint of suppressing head wear, the Mohs hardness of the second particles may be, for example, 10 or less, favorably 9.5 or less. That is, the second particles may be formed of a material having such a Mohs hardness.

The second particles may favorably be inorganic particles. The second particles may be, for example, α-alumina (α transformation rate may be, for example, 90% or more), β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing a raw material of magnetic iron oxide, those subjected to surface treatment with aluminum and/or silica as necessary, or a diamond powder, or a combination of two or more of these. As the second particles, alumina particles such as α-alumina, β-alumina, and γ-alumina, or silicon carbide is favorably used. These second particles may have any shape such as a needle shape, a spherical shape, and a dice shape, but those having a corner in part of the shape are favorable because they have high abrasivity, for example.

The average particle size (e.g., an arithmetic mean value of particle diameters measured using electron microscopy) of the second particles (particularly, inorganic particles, e.g., alumina) may be, for example, 15 nm or more, favorably 30 nm or more, and more favorably 50 nm or more. Further, the average particle size may be, for example, 200 nm or less, favorably 180 nm or less, and more favorably 150 nm or less, 130 nm or less, or 120 nm or less. The numerical range of the average particle size may be appropriately selected from these upper limit value and lower limit value, and may be, for example, 50 nm to 180 nm, favorably 60 nm to 150 nm, and more favorably 60 nm to 120 nm.

The second particles (particularly, inorganic particles, e.g., alumina) do not necessarily need to have conductivity. That is, the second particles do not necessarily need to have the conductivity that the first particles have.

### (Underlayer)

The underlayer 12 is a non-magnetic layer that includes a non-magnetic powder and a binder as main components. The underlayer 12 may further include at least one additive of another particle, a lubricant, a curing agent, and a rust inhibitor, as necessary.

The average thickness of the underlayer 12 may be favorably 1,200 nm or less, favorably 1,150 nm or less, 1,120 nm or less, or 1,100 nm or less, more favorably 1000 nm or less, 900 nm or less, 800 nm or less, or 700 nm or less, and still more favorably 600 nm or less. Further, the lower limit value of the average thickness of the underlayer is not particularly limited, but may be favorably 200 nm or more, more favorably 300 nm or more.

### (Non-Magnetic Powder)

The non-magnetic powder included in the underlayer 12 includes, for example, at least one selected from the group consisting of inorganic particles and organic particles, particularly, at least one selected from inorganic particles. One type of non-magnetic powder may be used alone, or two or more types of non-magnetic powders may be used in combination. The non-magnetic inorganic particles may be, for example, one selected from the group consisting of metal, metal oxide, metal carbonate, metal sulfate, metal nitride, metal carbide, and metal sulfide, or a combination of two or more of them. More specifically, the inorganic particle may be, for example, one or two or more selected from the group consisting of iron oxide, aluminum oxide, carbon black, iron oxyhydroxide, hematite, titanium oxide, silicon oxide, titanium carbide, silicon carbide, diamond, and calcium carbonate. Examples of the shape of the non-magnetic powder include, but not particularly limited to, various shapes such as a needle shape, a spherical shape, a cubic shape, and a plate shape.

### (Binder)

The underlayer includes a binder. The description regarding the binder included in the above-mentioned magnetic layer 13 also applies to the binder included in the underlayer 12.

### (Lubricant)

The underlayer may include a lubricant. The lubricant may be, for example, one or two or more selected from a fatty acid and/or a fatty acid ester, and the lubricant may favorably be the compound represented by the general chemical formula (1), the general chemical formula (2), the general chemical formula (3), or the general chemical formula (4) described above regarding the magnetic layer. One or a plurality of these compounds may be included.

Examples of the lubricant include esters of monobasic fatty acids having 10 to 24 carbon atoms and any of monovalent to hexavalent alcohols having 2 to 12 carbon atoms, mixed esters thereof, difatty acid esters, and trifatty acid esters. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, and octyl myristate. The magnetic layer may contain one or two or more of these.

### (Back Layer)

The back layer 14 may include a binder and a non-magnetic powder. The back layer 14 may include various additives such as a lubricant, a curing agent, and an antistatic agent, as necessary. The description regarding the binder and the non-magnetic powder included in the above-mentioned non-magnetic layer 12 also applies to the binder and the non-magnetic powder included in the back layer 14.

The average particle size of the inorganic particles included in the back layer 14 is favorably 10 nm or more and 150 nm or less, more favorably 15 nm or more and 110 nm or less. The average particle size of the inorganic particles is obtained in the same manner as that for the average particle size D of the above magnetic powder.

An average thickness t_{b} of the back layer 14 may be favorably 0.6 μm or less, more favorably 0.5 μm or less, and still more favorably 0.4 μm or less, 0.3 μm or less, 0.25 μm or less, or 0.2 μm or less. When the average thickness t_{b} of the back layer 14 is within the above range, the average thicknesses of the non-magnetic layer 12 and the base layer 11 can be kept large even in the case where an average thickness (average total thickness) t_{T} of the magnetic recording medium 10 satisfies the relationship of t_{T} 5.7 μm. This makes it possible to maintain travelling stability of the magnetic recording medium 10 in a recording/reproduction apparatus. Further, the lower limit value of the average thickness of the back layer is not particularly limited, but may be, for example, 0.1 μm or more, favorably 0.15 μm or more.

### (3) Physical Properties and Structure

### (Various Values Measured by Dynamic Mechanical Analysis)

An average value A_{(E″)} of loss elastic moduli E″ in the temperature range of 60° C. to 65° C., an average value A_{(E′)} of storage elastic moduli E′ in the temperature range, and an average value A_{(Tanδ}) of Tanδ s (loss elastic modulus E″/storage elastic modulus E′) in the temperature range are measured by executing dynamic mechanical analysis on the magnetic recording medium.

In the present technology, the average value A_{(E″)} of loss elastic moduli E″ in the temperature range of 60° C. to 65° C. is favorably 0.06 GPa or less, favorably 0.05 GPa or less, more favorably 0.04 GPa or less, and still more favorably 0.03 GPa or less. The average value A_{(E″)} of loss elastic moduli E″ within the above numerical range is favorable in order to improve preservation stability of the magnetic recording medium in a high-temperature environment and travelling stability after preservation in a high-temperature environment.

Further, the average value A_{(E″)} of loss elastic moduli E″ is, for example, 0 GPa or more, and may be particularly 0.001 GPa or more, 0.005 GPa or more, or 0.01 GPa or more.

In the present technology, the average value A_{(E′)} of storage elastic moduli E′ in the temperature range of 60° C. to 65° C. is, for example, 6 GPa or less, more favorably 5 GPa or less, still more favorably 4 GPa or less, and particularly favorably 3.5 GPa or less, 3.2 GPa or less, 3.0 GPa or less, or 2.8 GPa or less. The average value A_{(E′)} of storage elastic moduli E′ within the above numerical range is also favorable in order to improve preservation stability of the magnetic recording medium in a high-temperature environment and travelling stability after preservation in a high-temperature environment.

Further, the average value of the storage elastic moduli E′ is, for example, 0.1 GPa or more, and may be particularly 0.2 GPa or more, 0.5 GPa or more, or 1.0 GPa or more.

In the present technology, the average value A_{(Tanδ)} of Tanδs (loss elastic modulus E″/storage elastic modulus E′) in the temperature range of 60° C. to 65° C. is, for example, 0.017 or less, more favorably 0.016 or less, still more favorably 0.015 or less, and particularly favorably 0.014 or less. The average value A_{(Tanδ)} of Tanδs within the above numerical range is also favorable in order to improve preservation stability of the magnetic recording medium in a high-temperature environment and travelling stability after preservation in a high-temperature environment.

Further, the average value A_{(Tanδ)} of Tanδs is, for example, 0.001 or more, and may be particularly 0.002 or more or 0.005 or more.

The average value A_{(E″)} of loss elastic moduli E″ in the temperature range of 60° C. to 65° C., the average value A_{(E′)} of storage elastic moduli E′ in the temperature range, and the average value A_{(Tanδ)} of Tanδ s in the temperature range are measured by dynamic mechanical analysis. The dynamic mechanical analysis is temperature-dependent measurement, and is specifically performed as follows.

The magnetic tape T housed in the magnetic recording cartridge 10A is unwound, and samples each having a length of 22.0 mm in the tape longitudinal direction and a width of 4.0 mm in the tape width direction are cut out at three positions 20 m, 40 m, and 60 m from the connection part between the magnetic tape T and the leader tape LT. The dynamic mechanical analysis described below in detail is performed on each of the samples at these three positions to obtain average values A_{(E″20)}, A_{(E″40)}, and A_{(E″60)} of loss elastic moduli E″ in the temperature range of 60° C. to 65° C. The average values A_{(E″20)}, A_{(E″40)}, and A_{(E″60)} are respectively measurement values of the samples obtained at the positions of 20 m, 40 m, and 60 m. Then, the simple average value of the average values A_{(E″20)}, A_{(E″40)}, and A_{(E″60)} is the average value A_{(E″)} of loss elastic moduli E″ in the present technology.

The storage elastic moduli E′ are also measured by the dynamic mechanical analysis for measuring the loss elastic moduli E″. For this reason, by performing the dynamic mechanical analysis on each of the three samples, average values A_{(E′20)}, A_{(E′40)}, and A_{(E′60)} of the storage elastic moduli E′ are obtained. Then, the simple average value of the average values A_{(E′20)}, A_{(E′40)}, and A_{(E′60)} is the average value A_{(E′)} of storage elastic moduli E′ in the present technology.

Tanδs are also measured by the dynamic mechanical analysis for measuring the loss elastic moduli E″. For this reason, by performing the dynamic mechanical analysis on each of the three samples, average values A_{(Tanδ20)}, A_{(Tanδ40)}, and A_{(Tanδ60)} of Tanδs are obtained. Then, the simple average value of the three average values A_{(Tanδ20)}, A_{(Tanδ40)}, and A_{(Tanδ60)} is the average value A_{(Tanδ)} of Tanδs in the present technology.

First, both ends of the sample in the longitudinal direction are clamped to the measuring unit of a dynamic viscoelasticity measuring apparatus (RSA II (RSA-SL-OPT), manufactured by TA Instruments). Then, dynamic mechanical analysis is performed under the following measurement conditions.

### <Measurement Conditions>

Measurement temperature range: −10° C. to 180° C.
Heating rate: 2° C./min
Amplitude: expand and contract with the amplitude of 0.1% of the tape initial length
Measurement frequency: 10 Hz
Test Type: “Strain-Controlled”
Measurement Type: “Dynamic”
Environment in which apparatus is placed: temperature of 25° C., humidity of 50 RH %
Humidity control of measuring unit: none

More detailed settings regarding the measurement conditions of the apparatus are as follows. That is, as described below, in the measurement, tension is adjusted so as not to be 0 or less and strain is adjusted so as not to fall below the lower limit value of the transducer. The measurement conditions for these adjustments may be appropriately set by those skilled in the art, and the following settings may be adopted for the above dynamic viscoelasticity measuring apparatus, for example.
Option settings
Delay Before Test: OFF
Auto Tension (settings for adjusting tension so as not to be 0 or less):
   Mode Static Force Tracking Dynamic Force
   Auto Tension Direction Tension
   Initial Static Force 10.0 g
   Static>Dynamic Force by 5.0%
   Minimum Static Force 1.0 g
   Auto Tension Sensitivity 1.0 g
Auto Strain (settings for adjusting strain so as not to fall below the lower limit value of the transducer):
   Max Applied Strain 0.1%
   Max Allowed Force 100.0 g
   Min allowed Force 2.0 g
   Strain Adjustment 3.0%
Meas Ops: Default setting

The loss elastic moduli E″ at the measurement temperature of 60° C. to 65° C. are obtained by performing the dynamic mechanical analysis described above, and the loss elastic moduli E″ in the temperature range are simply averaged to obtain an average value of the loss elastic moduli E″ in the temperature range.

Further, storage elastic moduli E′ at the measurement temperature of 60° C. to 65° C. are obtained by performing the dynamic mechanical analysis, and the storage elastic moduli E′ in the temperature range are simply averaged to obtain an average value of the storage elastic moduli E′ in the temperature range.

Further, Tanδ is calculated from the loss elastic modulus E″ and the storage elastic modulus E′ at each temperature obtained by performing the dynamic mechanical analysis. Then, Tanδs at the measurement temperature of 60° C. to 65° C. are simply averaged to obtain an average value of Tanδs in the temperature range.

These average values can be adjusted by, for example, selecting the material of the base layer, adjusting the strength of the material of the base layer in the longitudinal direction and/or lateral direction, (adjusting the extending condition in the longitudinal direction and/or lateral direction), or adjusting the composition of the magnetic layer. For example, as the material of the base layer, the aromatic polyetherketone resin described above may be adopted, and particularly PEEK may be adopted.

Further, these average values can also be adjusted by adjusting the temperature and/or time of, for example, a strain relaxation process before cutting or a strain relaxation process before servo writing, of processes included in the method of producing the magnetic recording medium. These strain relaxation processes may be performed at, for example, 40° C. to 120° C. for 10 seconds to 100 hours. These relaxation processes may be executing while travelling or while the roll is stationary.

### (Average Height Rpk of Protruding Peak)

In the magnetic recording medium according to the present technology, the average height Rpk of protruding peaks measured using a non-contact profilometer using optical interference is, for example, 2.4 nm or less, favorably 2.3 nm or less, and more favorably 2.2 nm or less. The average height Rpk within the above numerical range is favorable in order to improve preservation stability of the magnetic recording medium in a high-temperature environment and travelling stability after preservation in a high-temperature environment.

Further, the average height Rpk is, for example, 0.5 nm or more, and may be particularly, 1.0 nm or more, 1.2 nm or more, or 1.5 nm or more.

The average height Rpk of protruding peaks can be adjusted by adjusting the composition of the magnetic layer and/or the time of dispersion treatment in producing a coating material for forming a magnetic layer. For example, the average height Rpk of protruding peaks can be adjusted by adjusting the type, particle size, content, or the like of particles (particularly, non-magnetic reinforcing particle) included in the magnetic layer.

Further, the average height Rpk of protruding peaks can also be adjusted by adjusting the surface properties of the base layer and/or the surface properties of the underlayer. Regarding the underlayer, for example, the surface properties of the underlayer can be adjusted by adjusting the amount of particles (e.g., carbon particles) and/or the time of dispersion treatment in producing a coating material for forming an underlayer. For example, by reducing the surface roughness of these layers, it is possible to reduce the average height Rpk.

The average height Rpk of protruding peaks is measured using a non-contact profilometer using optical interference. In the measurement, a bearing curve is created by software attached to the non-contact profilometer. The bearing curve is used to evaluate the properties of the surface subjected to strong mechanical contact. Using the bearing curve, recesses and projections of the surface can be divided into three parts of a protruding peak, a core part, and a protruding trough. Of these three parts, the protruding peak corresponds to a portion of the recesses and projections of the surface that is conceivable to be relatively easily worn. By adjusting the average height Rpk of protruding peaks of the surface on the side of the magnetic layer as described above, it is possible to improve travelling stability after preservation in a high-temperature environment. Further, this also makes it possible to provide favorable electromagnetic conversion characteristics.

A method of measuring the average height Rpk of protruding peaks will be described below.

Note that also in calculating the average height Rpk of protruding peaks, the magnetic tape T housed in the magnetic recording cartridge 10A is unwound, samples are cut out at three positions 20 m, 40 m, and 60 m from the connection part between the magnetic tape T and the leader tape LT, and these three samples are used. For each of the samples at three positions, an average height of protruding peaks is calculated as described below in detail to obtain Rpk₍₂₀₎, Rpk₍₄₀₎, and Rpk₍₆₀₎. Then, the simple average value of Rpk₍₂₀₎, Rpk₍₄₀₎, and Rpk₍₆₀₎ is the average height Rpk of protruding peaks in the present technology.

The average height Rpk of protruding peaks of the magnetic layer is measured as follows. First, the magnetic tape T having a width of 12.65 mm is prepared and cut out into a length of 100 mm to prepare a sample. Next, the sample is placed on a slide glass such that the surface of the sample to be measured (surface on the side of the magnetic layer) faces up, and the end portion of the sample is fixed with mending tape. A non-contact profilometer (VertScan, an objective lens 50 times) using optical interference is used as a measuring apparatus to measure the surface shape of the surface to be measured, a bearing curve is drawn using the attached analysis software, and the average height Rpk of protruding peaks is obtained.

The measurement conditions are as follows.
Apparatus: non-contact profilometer using optical interference
(non-contact surface/layer cross-sectional shape measurement system VertScan R5500GL-M100-AC manufactured by Ryoka Systems Inc.)
Objective lens: 50 times
CCD: ⅓ lens
Measurement region:640×480 pixels (field of view: approximately 95 μm×71 μm)
Measurement mode: phase
Wavelength filter: 520 nm
Noise removal filter smoothing 3×3
Surface correction: correction using a quadratic polynomial approximation surface
Measurement software: VS-Measure Version5.5.2
Analysis software: VS-viewer Version5.5.5

After measuring the surface shape of the sample on the side of the magnetic layer at at least five positions in the longitudinal direction as described above, an average value of the average heights Rpk of protruding peaks automatically calculated from bearing curves obtained at the respective positions is used as the average height Rpk of protruding peaks of the sample. Then, the simple average value of the average heights of protruding peaks obtained for the respective samples at the above-mentioned three positions is the average height Rpk of protruding peaks in the present technology.

(Width Variation after 40 Hours)

In the magnetic recording medium according to the present technology, a width variation ΔW₄₀ₕ when a weight of 0.55 N is applied in a longitudinal direction for 40 hours in an environment of a temperature of 65° C. and a humidity of 40% is, for example, −600 ppm≤ΔW₄₀ₕ, favorably−500 ppm≤ΔW₄₀ₕ, more favorably −400 ppm≤ΔW₄₀ₕ, and may be still more favorably −300 ppm≤ΔW₄₀ₕ, −250 ppm≤ΔW₄₀ₕ, or −200 ppm≤ΔW₄₀ₕ.

The upper limit value of the width variation ΔW₄₀ₕ may be, for example, ΔW₄₀ₕ≤0, particularly ΔW₄₀ₕ≤−10, ΔW₄₀ₕ≤−50, or ΔW₄₀ₕ≤−100.

By controlling the width variation ΔW₄₀ₕ of the magnetic recording medium as described above, the magnetic recording medium has excellent preservation stability in a high-temperature environment.

The width variation ΔW₄₀ₕ is measured as follows.

First, the magnetic recording medium 10 having a ½ inch is prepared and cut out into a length of 250 mm to prepare a sample 10S.

The magnetic tape T housed in the magnetic recording cartridge 10A is unwound, and the sample 10S is cut out at three positions 20 m, 40 m, and 60 m from the connection part between the magnetic tape T and the leader tape LT. For each of the three obtained samples, measurement is performed as follows to obtain three width variations ΔW_{40h (20)}, ΔW_{40h (40)}, and ΔW_{40h (60)}. The simple average value of these three width variations ΔW_{40h (20)}, ΔW_{40h (40)}, and ΔW_{40h (60)} is the width variation ΔW₄₀ₕ in the present technology.

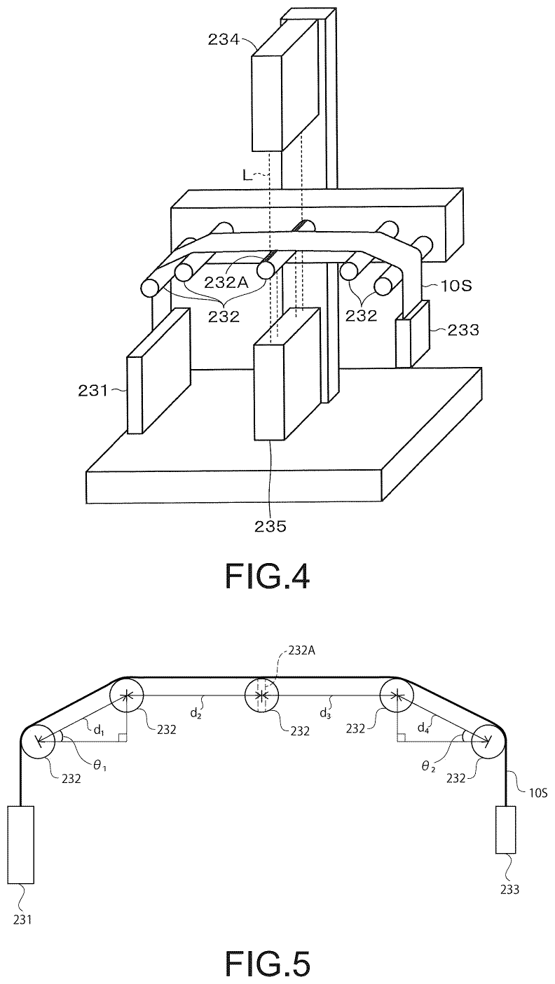

A measuring apparatus shown in FIG. 4 in which a digital dimension measuring device LS-7000 manufactured by KEYENCE CORPORATION is incorporated is prepared as a measuring apparatus, and the sample 10S is set in this measuring apparatus. Specifically, one end of the long sample (magnetic recording medium) 10S is fixed by a fixing part 231. Next, as shown in FIG. 4, the sample 10S is placed on five support members 232 each having a substantially columnar shape and a rod shape. The sample 10S is placed on theses support members such that the back surface thereof comes into contact with the five support members 232. The five support members 232 (particularly, the surfaces thereof) are formed of stainless steel SUS304, and have a surface roughness Rz (maximum height) is 0.15 μm to 0.3 μm.

Further, of the five support members 232, the third support member is fixed so as not to rotate, but the other four support members are rotatable.

Arrangement of the five support members 232 each having a rod shape will be described with reference to FIG. 5. As shown in FIG. 5, the sample 10S is placed on the five support members 232. The five support members 232 will be referred to as a “first support member”, a “second support member”, a “third support member” (having a slit 232A), a “fourth support member”, and a “fifth support member” (closest to a weight 233) below from the one closest to the fixing part 231. The diameter of each of the five support members is 7 mm. A distance d₁ between the first support member and the second support member (particularly, a distance between centers of these support members) is 20 mm. A distance d₂ between the second support member and the third support member is 30 mm. A distance d₃ between the third support member and the fourth support member is 30 mm. A distance d₄ between the fourth support member and the fifth support member is 20 mm. Further, the second support member, the third support member, and the fourth support member are disposed such that the portion of the sample 10S placed on these support members forms a plane substantially perpendicular to the direction of gravity. Further, the first support member and the second support member are disposed such that the sample 10S forms an angle 81=30° with respect to the substantially perpendicular plane between the first support member and the second support member. Further, the fourth support member and the fifth support member are disposed such that the sample 10S forms an angle θ₂=30° with respect to the substantially perpendicular plane between the fourth support member and the fifth support member.

Further, of the five support members 232, the third support member is fixed so as not to rotate, but the other four support members are rotatable.

The sample 10S is held on the support members 232 so as not to move in the width direction of the sample 10S. Note that the slit 232A is provided in the support member 232 that is located between a light emitter 234 and an optical receiver 235 and is located at substantially the center between the fixing part 231 and the part to which a weight is applied, of the support members 232. Light L is applied from the light emitter 234 to the optical receiver 235 through the slit 232A. The slit width of the slit 232A is 1 mm, and the light L is capable of passing through the width without being blocked by the frame of the slit 232A.

Subsequently, the measuring apparatus is housed in a chamber controlled under a constant environment of a temperature of 65° C. and a relative humidity of 40%, and then, the weight 233 for applying a weight of 0.55 N is attached to the other end of the sample 10S. That is, the sample 10S is pulled in the longitudinal direction by the weight of 0.55 N. In this state, the sample 10S is placed in the above environment for 40 hours.

During 40 hours in the above environment, the width of the sample 10S is measured every hour.

While the weight is applied, the light L is applied from the light emitter 234 to the optical receiver 235 to measure the width of the sample 10S to which the weight is applied in the longitudinal direction. The width is measured while the sample 10S is not curled. The light emitter 234 and the optical receiver 235 are included in the digital dimension measuring device LS-7000.

The difference between the width measured first (width 1 hour after the weight was applied) and the width measured last (width measured after 40 hours) is used as a width variation. That is, the width variation is represented by the following formula.
“Width variation”=“width measured after 40 hours”−“width 1 hour after the weight was applied”

Then, this width variation is acquired for the three samples obtained from three different positions. Then, the simple average value of the three width variations is the width variation ΔW₄₀ₕ according to the present technology.

### (Stiffness S)

A stiffness S of the magnetic recording medium according to the present technology is, for example, 1.4 mgf/μm or less, favorably 1.3 mgf/μm or less, 1.2 mgf/μm or less, 1.1 mgf/μm or less, or 1.0 mgf/μm or less, more favorably 0.9 mgf/μm or less, and still more favorably 0.8 mgf/μm or less.

Having the stiffness S described above contributes to improving travelling stability of the magnetic recording medium after preservation in a high-temperature environment.

The lower limit value of the stiffness S of the magnetic recording medium according to the present technology is not necessarily particularly limited, and may be, for example, 0.1 mgf/μm or more, particularly 0.2 mgf/μm or more, 0.3 mgf/μm or more, 0.4 mgf/μm or more, or 0.5 mgf/μm or more.

A method of measuring the stiffness S will be described below.

The magnetic tape T housed in the magnetic recording cartridge 10 is unwound, and samples are cut out at three positions 20 m, 40 m, and 60 m from the connection part between the magnetic tape T and the leader tape LT. Flexural rigidity of each of the three samples is measured in accordance with ECMA-319. Then, the arithmetic mean of the three flexural rigidity values obtained is the stiffness S in the present technology.

### (Average Thickness (Average Total Thickness) t_{T} of Magnetic Recording Medium)

An average thickness (average total thickness) t_{T} of the magnetic recording medium 10 may be, for example, 5.7 μm or less, favorably 5.6 μm or less, more favorably 5.5 μm or less, 5.4 μm or less, 5.3 μm or less, 5.2 μm or less, 5.1 μm or less, or 5.0 μm or less, and may be still more favorably 4.6 μm or less or 4.4 μm or less. When the average thickness t_{T} of the magnetic recording medium 10 is 5.5 μm or less, it is possible to increase the recording capacity of one data cartridge to be more than those of general magnetic tapes. The lower limit value of the average thickness t_{T} of the magnetic recording medium 10 is not particularly limited, but is, for example, 3.5 μm or more.

The average thickness t_{T} of the magnetic recording medium 10 (referred to also as the magnetic tape T in the present specification) is obtained as follows. Note that the average thickness t_{T} is referred to also as a total thickness t_{T}.

First, for example, the magnetic tape T housed in a cartridge such as the cartridge 10A described below is unwound, and the magnetic tape T is cut out into a length of 250 mm at positions 20 m, 40 m, and 60 m in the longitudinal direction from the connection part 221 between the magnetic tape T and the leader tape LT to prepare three samples. Next, the thickness of each sample is measured at five positions using a Laser Hologage (LGH-110° C.) manufactured by Mitutoyo Corporation as a measuring apparatus, and these measured values are simply averaged (arithmetically averaged) to calculate average thicknesses t_{T20}, t_{T40}, and t_{T60}. Note that the above five measurement positions are randomly selected from the sample such that they are different positions in the longitudinal direction of the magnetic tape T.

The arithmetic mean value of the average thicknesses t_{T20}, t_{T40}, and t_{T60} is the average thickness t_{T} of the magnetic recording medium in the present technology.

### (Average Thickness of Underlayer (Non-Magnetic Layer))

The average thickness of the underlayer 12 is obtained as follows. First, for example, the magnetic tape T housed in a cartridge such as the cartridge 10A described below is unwound, and the magnetic tape T is cut out at three positions 20 m, 40 m, and 60 m in the longitudinal direction from the connection part 221 between the magnetic tape T and the leader tape LT into a length of 250 mm to prepare three samples. Subsequently, each sample is processed by the FIB method or the like to obtain a slice. In the case of using the FIB method, a carbon layer and a tungsten layer are formed as protective films as pre-processing for observing a TEM image of a cross section described below. The carbon layer is formed on the surface on the side of the magnetic layer 13 and the surface on the side of the back layer 14 of the magnetic tape T by a vapor deposition method, and the tungsten layer is further formed on the surface on the side of the magnetic layer 13 by a vapor deposition method or a sputtering method. The slicing is performed along the longitudinal direction of the magnetic tape T. That is, the slicing forms a cross section parallel to both the longitudinal direction and the thickness direction of the magnetic tape T.

The above cross section of each obtained sliced sample is observed using a transmission electron microscope (TEM) under the following conditions.
Apparatus: TEM (H9000 NAR manufactured by Hitachi, Ltd.)
Acceleration voltage: 300 kV
Magnification: 100,000 times

Next, the thickness of the underlayer 12 is measured at at least 10 positions in the longitudinal direction of the magnetic tape T using the obtained TEM image, and then, these measured values are simply averaged (arithmetically averaged) to obtain underlayer average thicknesses of the three samples. The arithmetic mean of the three obtained underlayer average thicknesses is the average thickness of the underlayer included in the magnetic recording medium according to the present technology.

### (Average Thickness of Base Layer)

The average thickness of the base layer 11 is obtained as follows. First, for example, the magnetic tape T housed in a cartridge such as the magnetic recording cartridge 10A described below is unwound, and the magnetic tape T is cut out into a length of 250 mm at three positions 20 m, 40 m, and 60 m in the longitudinal direction from the connection part 221 between the magnetic tape T and the leader tape LT to prepare three samples. In the present specification, the “longitudinal direction” in the “longitudinal direction from the connection part between the magnetic tape T and the leader tape LT” means a direction from one end on the side of the leader tape LT to the other side on the side opposite thereto.

Subsequently, the layers other than the base layer 11 of the sample (i.e., the non-magnetic layer (underlayer) 12, the magnetic layer 13, and the back layer 14) are removed using a solvent such as MEK (methyl ethyl ketone) and dilute hydrochloric acid. Next, the thickens of the sample (base layer 11) is measured at five positions using a Laser Hologage (LGH-110° C.) manufactured by Mitutoyo Corporation as a measuring apparatus, and these measured values are simply averaged (arithmetically averaged) to calculate base layer average thicknesses of the three samples. Note that the above five measurement positions are randomly selected from the sample such that they are different positions in the longitudinal direction of the magnetic tape T.

The arithmetic mean of the three obtained base layer average thicknesses is the average thickness of the base layer included in the magnetic recording medium according to the present technology.

### (Average Thickness t_{b} of Back Layer)

The upper limit value of the average thickness of the back layer 14 is favorably 0.6 μm or less. When the upper limit value of the average thickness of the back layer 14 is 0.6 μm or less, the thicknesses of the underlayer (non-magnetic layer) 12 and the base layer 11 can be kept large even in the case where the average thickness of the magnetic tape T is 5.6 μm or less, and thus, it is possible to maintain the travelling stability of the magnetic tape T in a recording/reproduction apparatus. The lower limit value of the average thickness of the back layer 14 is not particularly limited, but is, for example, 0.2 μm or more.

The average thickness t_{b} of the back layer 14 is obtained as follows. First, the average thickness (average total thickness) t_{T} of the magnetic tape T is measured. The method of measuring the average thickness t_{T} (average total thickness) is as described above. Subsequently, the magnetic tape T housed in the cartridge 10A is unwound, and the magnetic tape T is cut out into a length of 250 mm at three positions 20 m, 40 m, and 60 m in the longitudinal direction from the connection part 221 between the magnetic tape T and the leader tape LT to prepare three samples. Next, the back layer 14 of each sample is removed using a solvent such as MEK (methyl ethyl ketone) and dilute hydrochloric acid. Next, the thickness of each sample is measured at five positions using a Laser Hologage (LGH-110° C.) manufactured by Mitutoyo Corporation, and these measured values are simply averaged (arithmetically averaged) to calculate average values (t_{B20}, t_{B40}, and t_{B60}) [μm] of the respective samples. The t_{B20}, t_{B40}, and t_{B60} are respectively average values at the positions of 20 m, 40 m, and 60 m. Then, an arithmetic mean t_{B} of the average values at these three positions is obtained. Note that the above five measurement positions are randomly selected from the sample such that they are different positions in the longitudinal direction of the magnetic tape T.

After that, the average thickness t_{b} [μm] of the back layer 14 is obtained from the following formula.

t_{b}[μm]=t_{T}[μm]−t_{B} [μm]

### (Average Thickness tₘ of Magnetic Layer)

The average thickness tₘ of the magnetic layer 13 is obtained as follows. First, the magnetic tape T housed in the cartridge 10A is unwound, and the magnetic tape T is cut out into a length of 250 mm at three positions 20 m, 40 m, and 60 m in the longitudinal direction from the connection part 221 between the magnetic tape T and the leader tape LT to prepare three samples. Subsequently, each sample is processed by the FIB method or the like to obtain a slice. In the case of using the FIB method, a carbon layer and a tungsten layer are formed as protective films as pre-processing for observing a TEM image of a cross section described below. The carbon layer is formed on the surface on the side of the magnetic layer 13 and the surface on the side of the back layer 14 of the magnetic tape T by a vapor deposition method, and the tungsten layer is further formed on the surface on the side of the magnetic layer 13 by a vapor deposition method or a sputtering method. The slicing is performed along the longitudinal direction of the magnetic tape T. That is, the slicing forms a cross section parallel to both the longitudinal direction and the thickness direction of the magnetic tape T.

The above cross section of each obtained sliced sample is observed using a transmission electron microscope (TEM) under the following conditions to obtain a TEM image of each sliced sample. Note that the magnification and acceleration voltage may be appropriately adjusted in accordance with the type of apparatus.
Apparatus: TEM (H9000 NAR manufactured by Hitachi, Ltd.)
Acceleration voltage: 300 kV
Magnification: 100,000 times

Next, the thickness of the magnetic layer 13 is measured at 10 positions of each sliced sample using the TEM image of each obtained sliced sample. Note that the 10 measurement positions of each sliced sample are randomly selected from the sample such that they are different positions in the longitudinal direction of the magnetic tape T. An average value obtained by simply averaging (arithmetically averaging) the measured values (total of 30 thicknesses of the magnetic layer 13) of each obtained sliced sample is used as the average thickness tₘ [nm] of the magnetic layer 13.

### (Squareness Ratio Rs2 in Perpendicular Direction)

A squareness ratio Rs2 in the perpendicular direction (thickness direction) of the magnetic recording medium according to the present technology may be favorably 65% or more, more favorably 67% or more, and still more favorably 70% or more. When the squareness ratio Rs2 is 65% or more, the perpendicular orientation of the magnetic powder becomes sufficiently high, and thus, more excellent SNR can be obtained. Therefore, it is possible to achieve more excellent electromagnetic conversion characteristics. Further, the shape of the servo signal is improved, which makes the control on the drive side easier.

In the present specification, the magnetic recording medium being perpendicularly oriented may mean that the squareness ratio Rs2 of the magnetic recording medium is within the above numerical range (e.g., 65% or more).

The squareness ratio Rs2 in the perpendicular direction is obtained as follows. First, the magnetic tape T housed in the magnetic recording cartridge 10A is unwound, and the magnetic tape T is cut out into a length of 250 mm at a position 30 m in the longitudinal direction from the connection part 221 between the magnetic tape T and the leader tape LT to prepare a sample. The sample is punched out into 6.25 mm×64 mm, and then fold into three to prepare a measurement sample of 6.25 mm×8 mm. Then, an M-H hysteresis loop of the measurement sample (entire magnetic tape T) corresponding to the perpendicular direction (thickness direction) of the magnetic tape T is measured using a VSM. Next, acetone, ethanol, or the like is used to wipe off the coating film (the underlayer 12, the magnetic layer 13, and the back layer 14, etc.), leaving only the base layer 11. Then, the obtained base layer 11 is punched out into 6.25 mm×64 mm, and then folded into three to prepare a sample for background correction of 6.25 mm×8 mm (hereinafter, referred to simply as a “correction sample”). After that, an M-H hysteresis loop of the correction sample (base layer 11) corresponding to the perpendicular direction of the base layer 11 (perpendicular direction of the magnetic recording medium 10) is measured using the VSM.

In the measurement of the M-H hysteresis loop of the measurement sample (entire magnetic tape T) and the measurement of the M-H hysteresis loop of the correction sample (base layer 11), a highly sensitive vibrating sample magnetometer “VSM-P7-15” manufactured by TOEI INDUSTRY CO., LTD. is used. The measurement conditions are the measurement mode: full-loop, the maximum magnetic field: 15 kOe, the magnetic field step: 40 bits, the time constant of locking amp: 0.3 sec, the waiting time: 1 sec, and the MH average number: 20.

After obtaining the M-H hysteresis loop of the measurement sample (entire magnetic tape T) and the M-H hysteresis loop of the correction sample (base layer 11), the M-H hysteresis loop of the correction sample (base layer 11) is subtracted from the M-H hysteresis loop of the measurement sample (entire magnetic tape T) to perform background correction, thereby obtaining an M-H hysteresis loop after background correction. The measurement/analysis program attached to the “VSM-P7-15” is used for this calculation of background correction.

A saturation magnetization amount Ms (emu) and residual magnetization Mr (emu) of the obtained M-H hysteresis loop after background correction are substituted into the following formula to calculate the squareness ratio Rs2 (%). Note that the measurement of the above M-H hysteresis loops is performed at 25° C. Further, “demagnetizing field correction” when measuring the M-H hysteresis loop in the perpendicular direction of the magnetic tape T is not performed. The measurement/analysis program attached to the “VSM-P7-15” is used for this calculation.

$$Squareness ratio Rs 2 ( \% ) = ( Mr / Ms ) \times 100$$

### (4) Method of Producing Magnetic Recording Medium

Next, a method of producing the magnetic recording medium 10 having the above-mentioned configuration will be described. First, a non-magnetic powder, a binder, and the like are kneaded and/or dispersed in a solvent to prepare a paint for forming an underlayer (non-magnetic layer). Next, a magnetic powder, non-magnetic particles, a binder, and the like are kneaded and/or dispersed in a solvent to prepare a coating material for forming a magnetic layer. For the preparation of the coating material for forming a magnetic layer and the paint for forming an underlayer (non-magnetic layer), the following solvent, dispersing apparatus, and kneading apparatus can be used, for example.

As described above, the average height Rpk of protruding peaks can be adjusted by adjusting the type and/or content of non-magnetic reinforcing particles included in the coating material for forming a magnetic layer.

Examples of the solvent to be used for preparing the above-mentioned paint include a ketone solvent such as acetone, methyl ethyl ketone, methylisobutyl ketone, and cyclohexanone; an alcohol solvent such as methanol, ethanol, and propanol; an ester solvent such as methyl acetate, ethyl acetate, butyl acetate, propyl acetate, ethyl lactate, and ethylene glycol acetate; an ether solvent such as diethylene glycol dimethyl ether, 2-ethoxyethanol, tetrahydrofuran, and dioxane; an aromatic hydrocarbon solvent such as benzene, toluene, and xylene; and a halogenated hydrocarbon solvent such as methylene chloride, ethylene chloride, carbon tetrachloride, chloroform, and chlorobenzene. One of these may be used or a mixture of two or more of them may be used.

As the kneading apparatus to be used for preparing the above-mentioned paint, for example, a kneading apparatus such as a continuous twin-screw kneader, a continuous twin-screw kneader capable of performing dilution in multiple stages, a kneader, a pressure kneader, and a roll kneader can be used, but it does not necessarily need to use these apparatuses. Further, as the dispersing apparatus to be used for preparing the above-mentioned paint, for example, a dispersing apparatus such as a bead mill, a roll mill, a ball mill, a horizontal sand mil, a perpendicular sand mil, a spike mill, a pin mill, a tower mill, a pearl mill (e.g., “DCP mill” manufactured by Eirich Co., Ltd.), a homogenizer, and an ultrasonic disperser can be used, but it does not necessarily need to use these apparatuses.

Next, the coating material for forming an underlayer is applied onto one main surface of the base layer 11 and dried to form the underlayer 12. Subsequently, the coating material for forming a magnetic layer is applied onto this underlayer 12 and dried to form the magnetic layer 13 on the non-magnetic layer 12.

Note that during drying, for example, the magnetic field of the magnetic powder is oriented by a solenoid coil in the thickness direction of the base layer 11. Further, during drying, for example, the magnetic field of the magnetic powder may be oriented by a solenoid coil in the longitudinal direction (travelling direction) of the base layer 11 and then oriented in the thickness direction of the base layer 11. By performing such magnetic field orientation treatment, it is possible to reduce a ratio Hc2/Hc1 of a coercive force “Hc2” in the longitudinal direction to a coercive force “Hc1” in the perpendicular direction, and improve the degree of perpendicular orientation of the magnetic powder. After forming the magnetic layer 13, the back layer 14 is formed on the other main surface of the base layer 11. As a result, the magnetic recording medium 10 is obtained.

The ratio Hc2/Hc1 is set to a desired value by adjusting, for example, the strength of the magnetic field to be applied to the coating film of the coating material for forming a magnetic layer, the concentration of solid content in the coating material for forming a magnetic layer, or the drying conditions (drying temperature and drying time) of the coating material for forming a magnetic layer. The strength of the magnetic field to be applied to the coating film is favorably two times or more and three times or less the coercive force of the magnetic powder. In order to further increase the ratio Hc2/Hc1, it is also favorable to magnetize the magnetic powder before the coating material for forming a magnetic layer enters an orientation apparatus for orienting the magnetic field of the magnetic powder. Note that the methods of adjusting the ratio Hc2/Hc1 may be used alone, or two or more of them may be used in combination.

After that, the obtained magnetic recording medium 10 is wound around a large-diameter core, and the curing treatment is performed thereon. Finally, the magnetic recording medium 10 is calendered and then cut into a predetermined width (e.g., ½ inch width).

Further, the production method may include a strain relaxation process of relaxing the strain of the magnetic recording medium before the cutting.

Further, the production method may include a servo signal recording process of recording a servo signal after the cutting and a strain relaxation process of relaxing the strain of the magnetic recording medium after the servo signal recording process.

By adjusting the temperature and/or time in these strain relaxation processes, it is possible to adjust the average value A_{(E″)} of loss elastic moduli E″, the average value A_{(E′)} of storage elastic moduli E′, the average value A_{(Tanδ)} of Tanδ s, and the width variation ΔW₄₀ₕ.

By the production method described above, the desired long and thin magnetic recording medium 10 is obtained.

### (5) Recording/Reproduction Apparatus

### [Configuration of Recording/Reproduction Apparatus]

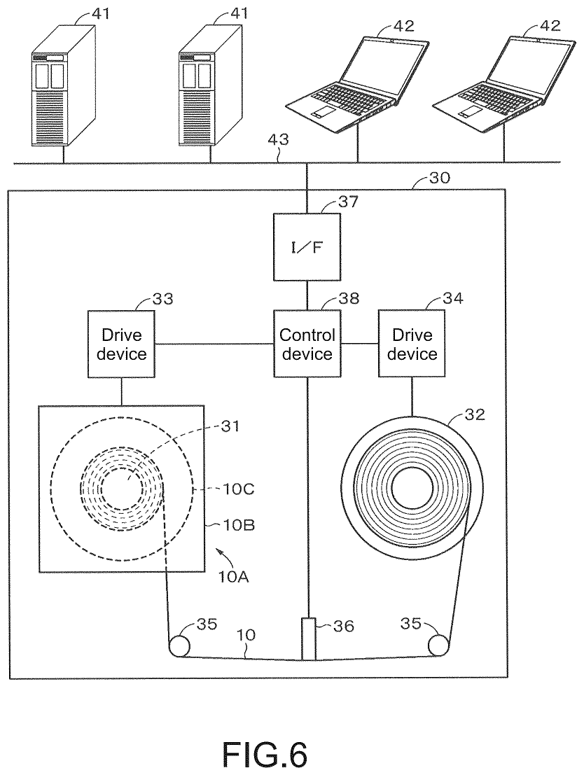

Next, an example of a configuration of a recording/reproduction apparatus 30 that records and reproduces the magnetic recording medium 10 having the above-mentioned configuration will be described with reference to FIG. 6.

The recording/reproduction apparatus 30 may be configured to be capable of adjusting tension to be applied to the magnetic recording medium 10 in the longitudinal direction. Further, the recording/reproduction apparatus 30 has a configuration in which the magnetic recording cartridge 10A can be loaded. Here, for ease of description, a case where the recording/reproduction apparatus 30 has a configuration in which one magnetic recording cartridge 10A can be loaded will be described. However, the recording/reproduction apparatus 30 may have a configuration in which a plurality of magnetic recording cartridges 10A can be loaded.

The recording/reproduction apparatus 30 is favorably a timing servo type magnetic recording/reproduction apparatus. The magnetic recording medium according to the present technology is suitable for use in the timing servo type magnetic recording/reproduction apparatus.

The recording/reproduction apparatus 30 is connected to an information processing apparatus such as a server 41 and a personal computer (hereinafter, referred to as “PC”.) 42 via a network 43, and is configured to be capable of recording data supplied from these information processing apparatuses on the magnetic recording cartridge 10A. The shortest recording wavelength of the recording/reproduction apparatus 30 is favorably 100 nm or less, more favorably 75 nm or less, still more favorably 60 nm or less, and particularly favorably 50 nm or less.

As shown in FIG. 6, the recording/reproduction apparatus includes a spindle 31, a reel 32 on the side of the recording/reproduction apparatus, a spindle drive device 33, a reel drive device 34, a plurality of guide rollers 35, a head unit 36, a communication interface (hereinafter, I/F) 37, and a control device 38.

The spindle 31 is configured to be capable of loading the magnetic recording cartridge 10A. The magnetic recording cartridge 10A conforms to the LTO (Linear Tape Open) standard, and rotatably houses, in a cartridge case 10B, a single reel 10C on which the magnetic recording medium 10 is wound. A servo pattern of the inverted V shape is recorded on the magnetic recording medium 10 in advance as a servo signal. The reel 32 is configured to be capable of fixing the tip of the magnetic recording medium 10 pulled out from the magnetic recording cartridge 10A.

The present technology also provides a magnetic recording cartridge that includes the magnetic recording medium according to the present technology. In the magnetic recording cartridge, the magnetic recording medium may be wound around, for example, a reel, and may be housed in a case while being wound around the reel.

The spindle drive device 33 is a device that causes the spindle 31 to be driven to rotate. The reel drive device 34 is a device that causes the reel 32 to be driven to rotate. When recording or reproducing data on/from the magnetic recording medium 10, the spindle drive device 33 and the reel drive device 34 cause the spindle 31 and the reel 32 to be driven to rotate to cause the magnetic recording medium 10 to travel. The guide roller 35 is a roller for guiding the travelling of the magnetic recording medium 10.

The head unit 36 includes a plurality of recording heads for recording a data signal on the magnetic recording medium 10, a plurality of reproduction heads for reproducing the data signal recorded on the magnetic recording medium 10, and a plurality of servo heads for reproducing the servo signal recorded on the magnetic recording medium 10. For example, a ring-type head can be used as the recording head, but the type of recording head is not limited thereto.

The communication I/F 37 is for communicating with an information processing apparatus such as the server 41 and the PC 42 and is connected to the network 43.

The control device 38 controls the entire recording/reproduction apparatus 30. For example, the control device 38 records the data signal supplied from the information processing apparatus on the magnetic recording medium 10 by the head unit 36 in accordance with a request from the information processing apparatus such as the server 41 and the PC 42. Further, the control device 38 reproduces the data signal recorded on the magnetic recording medium 10 and supplies the reproduced data signal to the information processing apparatus by the head unit 36 in accordance with a request from the information processing apparatus such as the server 41 and the PC 42.

Further, the control device 38 detects a change in the width of the magnetic recording medium 10 on the basis of the servo signal supplied from the head unit 36. Specifically, a plurality of servo patterns each having the inverted V shape is recorded on the magnetic recording medium 10 as servo signals, and the head unit 36 is capable of simultaneously reproducing two different servo patterns and obtaining respective servo signals by the two servo heads on the head unit 36. The relative position information between the servo pattern and the head unit obtained from this servo signal is used to control the position of the head unit 36 so as to follow the servo pattern. At the same time, it is also possible to obtain distance information between servo patterns by comparing the two servo signal waveforms. By comparing the distance information between servo patterns obtained at each measurement time, it is possible to obtain a change in the distance between servo patterns at each measurement time. By adding the distance information between servo patterns during servo pattern recording thereto, it is also possible to calculate a change in the width of the magnetic recording medium 10. On the basis of the change in the distance between servo patterns obtained as described above or the calculated change in the width of the magnetic recording medium 10, the control device 38 controls the driving rotation of the spindle drive device 33 and the reel drive device 34, and adjusts the tension of the magnetic recording medium 10 in the longitudinal direction such that the width of the magnetic recording medium 10 becomes a specified width or a substantially specified width. As a result, it is possible to suppress the change in the width of the magnetic recording medium 10.

### [Operation of Recording/Reproduction Apparatus]

Next, the operation of the recording/reproduction apparatus 30 having the above configuration will be described.

First, the magnetic recording cartridge 10A is loaded into the recording/reproduction apparatus 30, and the tip of the magnetic recording medium 10 is pulled out, transferred to the reel 32 via the plurality of guide rollers 35 and the head unit 36, and attached to the reel 32.

Next, when an operation unit (not shown) is operated, the spindle drive device 33 and the reel drive device 34 are driven under the control of the control device 38, and the spindle 31 and the reel 32 are caused to rotate in the same direction such that the magnetic recording medium 10 travels from the reel 10C to the reel 32. As a result, while the magnetic recording medium 10 is wound up by the reel 32, information is recorded on the magnetic recording medium 10 or information recorded on the magnetic recording medium 10 is reproduced by the head unit 36.

Further, in the case where the magnetic recording medium 10 is rewound to the reel 10C, the spindle 31 and the reel 32 are caused to be driven to rotate in the direction opposite to the above direction, thereby causing the magnetic recording medium 10 to travel from the reel 32 to the reel 10C. Also in this rewinding, information is recorded on the magnetic recording medium 10 or information recorded on the magnetic recording medium 10 is reproduced by the head unit 36.

### (6) Modified Example

### Modified Example 1

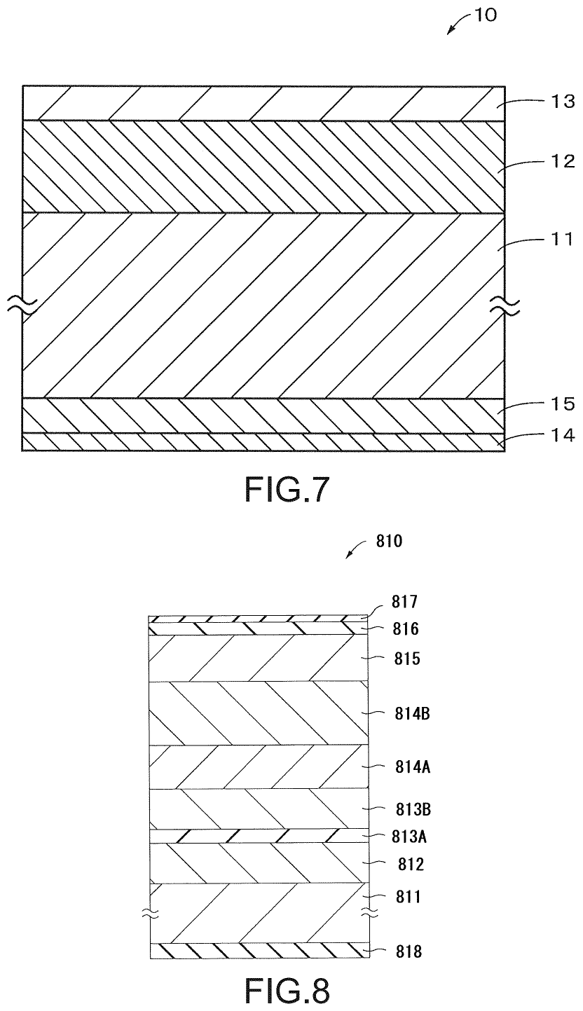

As shown in FIG. 7, the magnetic recording medium 10 may further include a barrier layer 15 provided on at least one surface of the base layer 11. The barrier layer 15 is a layer for suppressing dimensional deformation of the base layer 11 depending on the environment. Examples of the cause of the dimensional deformation include hygroscopicity of the base layer 11, and the barrier layer 15 makes it possible to reduce the rate of moisture entering the base layer 11. The barrier layer 15 contains metal or metal oxide. As the metal, at least one of Al, Cu, Co, Mg, Si, Ti, V, Cr, Mn, Fe, Ni, Zn, Ga, Ge, Y, Zr, Mo, Ru, Pd, Ag, Ba, Pt, Au, or Ta can be used. As the metal oxide, for example, at least one of Al₂O₃, CuO, COO, SiO₂, Cr₂O₃, TiO₂, Tσ₂O₅, and ZrO₂ can be used, or any of oxides of the above metals can also be used. Further, diamond-like carbon (DLC) or the like can also be used.

The average thickness of the barrier layer 15 is favorably 20 nm or more and 1,000 nm or less, and more favorably 50 nm or more and 1,000 nm or less. The average thickness of the barrier layer 15 is obtained in the same manner as that for the average thickness tₘ of the magnetic layer 13. However, the magnification of the TEM image is appropriately adjusted in accordance with the thickness of the barrier layer 15.

### Modified Example 2

The magnetic recording medium 10 may be incorporated into a library apparatus. That is, the present technology also provides a library apparatus including at least one magnetic recording medium 10. The library apparatus has a configuration capable of adjusting the tension to be applied to the magnetic recording medium 10 in the longitudinal direction, and may include a plurality of recording/reproduction apparatuses 30 described above.

### Modified Example 3

The magnetic recording medium 10 may be subjected to servo signal writing processing by a servo writer. By adjusting the tension in the longitudinal direction of the magnetic recording medium 10 when the servo writer records a servo signal, for example, the width of the magnetic recording medium 10 can be kept constant or substantially constant. In this case, the servo writer may include a detection device that detects the width of the magnetic recording medium 10. The servo writer may adjust the tension in the longitudinal direction of the magnetic recording medium 10 on the basis of the detection result of the detection device.

### 3. Second Embodiment (Example of Vacuum Thin-Film Recording Medium)

### (1) Configuration of Magnetic Recording Medium

An example of a magnetic recording medium according to this embodiment will be described with reference to FIG. 8. In the figure, a schematic cross-sectional view of a vacuum thin-film recording medium 810 according to this embodiment is shown. The magnetic recording medium 810 is a long perpendicular magnetic recording medium, and includes a film-shaped base layer 811, a soft magnetic underlayer (hereinafter, referred to as “SUL”.) 812, a first seed layer 813A, a second seed layer 813B, a first underlayer 814A, a second underlayer 814B, and a magnetic layer 815, as shown in the figure. The SUL 812, the first and second seed layers 813A and 813B, the first and second underlayers 814A and 814B, and the magnetic layer 815 may each be, for example, a vacuum thin-film such as a layer formed by sputtering (hereinafter, referred to also as a “sputter layer”).

The SUL 812, the first and second seed layers 813A and 813B, and the first and second underlayers 814A and 814B are provided between one main surface of the base layer 811 (hereinafter, referred to as a “front surface”.) and the magnetic layer 815, and the SUL 812, the first seed layer 813A, the second seed layer 813B, the first underlayer 814A, and the second underlayer 814B are stacked in this order from the base layer 811 toward the magnetic layer 815.

The magnetic recording medium 810 may further include a protective layer 816 provided on the magnetic layer 815 and a lubricant layer 817 provided on the protective layer 816 as necessary. Further, the magnetic recording medium 810 may further include a back layer 818 provided on the other main surface of the base layer 811 (hereinafter, referred to as a “back surface”.) as necessary.

The magnetic recording medium according to the second embodiment has excellent preservation stability when preserved in a high-temperature environment and excellent travelling stability after the preservation, similarly to the first embodiment. Further, the magnetic recording medium also has excellent electromagnetic conversion characteristics.

Hereinafter, the longitudinal direction of the magnetic recording medium 810 (longitudinal direction of the base layer 811) will be referred to as a machine direction (MD). Here, the machine direction means the direction in which the recording and reproduction heads move relative to the magnetic recording medium 810, i.e., the magnetic recording medium 810 is caused to travel during recording and reproduction.

The magnetic recording medium 810 is suitable for use as a storage medium for data archives, the demand for which is expected to further increase in the future. This magnetic recording medium 810 is capable of realizing, for example, areal recording density of 10 times or more that of the current coating type magnetic recording medium for storage, i.e., areal recording density of 50 Gb/in² or more. In the case where the magnetic recording medium 810 having such areal recording density is used to constitute a general linear recording data cartridge, it is possible to achieve large-capacity recording of 100 TB or more per data cartridge.

The magnetic recording medium 810 is suitable for use in a recording/reproduction apparatus (recording/reproduction apparatus for recording and reproducing data) that includes a ring-type recording head and a giant magnetoresistive (GMR) type, or tunneling magnetoresistive (TMR) type reproduction head. Further, in the magnetic recording medium 810 according to the second embodiment, it is favorable that a ring-type recording head is used as a servo signal writing head. A data signal is perpendicularly recorded on the magnetic layer 815 by, for example, a ring-type recording head. Further, a servo signal is perpendicularly recorded on the magnetic layer 815 by, for example, a ring-type recording head.

### (2) Description of Each Layer

### (Base Layer)

Since the description regarding the base layer 11 in the first embodiment applies to the base layer 811, description of the base layer 811 is omitted. Note that the average thickness of the base layer 811 is measured in the same manner as that for the base layer in the first embodiment except that the layers of each sample other than the base layer are removed using a solvent such as MEK (methyl ethyl ketone) and dilute hydrochloric acid and then washed with pure water.

### (SUL)

The SUL 812 contains a soft magnetic material in an amorphous state. The soft magnetic material contains, for example, at least one of a Co material and an Fe material. The Co material includes, for example, CoZrNb, CoZrTa, or CoZrTaNb. The Fe material includes, for example, FeCoB, FeCoZr, or FeCoTa.

The SUL 812 is an SUL of a single layer and is provided directly on the base layer 811. The average thickness of the SUL 812 is favorably 10 nm or more and 50 nm or less, more favorably 20 nm or more and 30 nm or less.

The average thickness of the SUL 812 is obtained in the same manner as the method of measuring the average thickness of the magnetic layer 13 in the first embodiment. Note that the average thicknesses of the layers other than the SUL 812 (i.e., average thickness of the first and second seed layers 813A and 813B, the first and second underlayers 814A and 814B, and the magnetic layer 815) described below are obtained in the same manner as the method of measuring the average thickness of the magnetic layer 13 in the first embodiment. However, the magnification of the TEM image is appropriately adjusted in accordance with the thickness of each layer.

### (First and Second Seed Layers)

The first seed layer 813A contains an alloy including Ti and Cr, and has an amorphous state. Further, this alloy may further include O (oxygen). This oxygen may be impurity oxygen contained in a trace amount in the first seed layer 813A when the first seed layer 813A is deposited by a deposition method such as a sputtering method.

Here, the “alloy” means at least one of a solid solution, eutectic, and intermetallic compound containing Ti and Cr. The “amorphous state” means that a halo is observed by X-ray diffraction, electron beam diffraction, or the like and the crystal structure cannot be identified.

The atomic ratio of Ti to the total amount of Ti and Cr contained in the first seed layer 813A is within the range of favorably 30 at % or more and less than 100 at %, more favorably 50 at % or more and less than 100 at %. When the atomic ratio of Ti is less than 30%, the (100) plane of the body-centered cubic lattice (bcc) structure of Cr is oriented, and there is a possibility that the orientation of the first and second underlayers 814A and 814B formed on the first seed layer 813A deteriorates.

The above atomic ratio of Ti is obtained as follows. While ion milling the magnetic recording medium 810 from the side of the magnetic layer 815, depth direction analysis (depth profile measurement) is performed on the first seed layer 813A by auger electron spectroscopy (hereinafter, referred to as “AES”.). Next, the average composition (average atomic ratio) of Ti and Cr in the film thickness direction is obtained from the obtained depth profile. Next, the above atomic ratio of Ti is obtained using the obtained average composition of Ti and Cr.

In the case where the first seed layer 813A contains Ti, Cr, and O, the atomic ratio of 0 to the total amount of Ti, Cr, and O contained in the first seed layer 813A is favorably 15 at % or less, more favorably 10 at % or less. When the atomic ratio of 0 exceeds 15 at %, a TiO₂ crystal is generated, which affects crystal nucleation in the first and second underlayers 814A and 814B formed on the first seed layer 813A, and there is a possibility that the orientation of the first and second underlayers 814A and 814B deteriorates. The above atomic ratio of 0 is obtained using the same analysis method as that for the above atomic ratio of Ti.

The alloy contained in the first seed layer 813A may further include an element other than Ti and Cr as an additive element. This additive element may be, for example, one or more elements selected from the group consisting of Nb, Ni, Mo, Al, and W.

The average thickness of the first seed layer 813A is favorably 2 nm or more and 15 nm or less, more favorably 3 nm or more and 10 m or less.

The second seed layer 813B contains, for example, NiW or Ta, and has a crystalline state. The average thickness of the second seed layer 813B is favorably 3 nm or more and 20 nm or less, more favorably 5 nm or more and 15 nm or less.

The first and second seed layers 813A and 813B each have a crystal structure similar to those of the first and second underlayers 814A and 814B, are not seed layers provided for the purpose of crystal growth, and are seed layers for improving perpendicular orientation of the first and second underlayers 814A and 814B by the amorphous state of the first and second seed layers 813A and 813B.

### (First and Second Underlayers)

It is favorable that the first and second underlayers 814A and 814B have a crystal structure similar to that of the magnetic layer 815. In the case where the magnetic layer 815 contains a Co alloy, the first and second underlayers 814A and 814B contain a material having a hexagonal close-packed (hcp) structure similar to that of the Co alloy, and it is favorable that the ε-axis of the structure is oriented in the perpendicular direction to the film surface (i.e., the film thickness direction). This is because the orientation of the magnetic layer 815 can be improved and the matching of lattice constant between the second underlayer 814B and the magnetic layer 815 can be made relatively favorable. As the material having a hexagonal close-packed (hcp) structure, it is favorable to use a material containing Ru, and specifically, Ru alone or an Ru alloy is favorable. Examples of the Ru alloy include an Ru alloy oxide such as Ru—SiO₂, Ru—TiO₂, and Ru—ZrO₂, and the Ru alloy may be any one of these.

As described above, similar materials can be used as the materials of the first and second underlayers 814A and 814B. However, the intended effects of the first and second underlayers 814A and 814B are different from each other. Specifically, the second underlayer 814B has a film structure for promoting the granular structure of the magnetic layer 815 that is the upper layer thereof, and the first underlayer 814A has a film structure with high crystal orientation. In order to obtain such a film structure, it is favorable to make the deposition conditions such as the sputtering conditions for the first and second underlayers 814A and 814B different from each other.

The average thickness of the first underlayer 814A is favorably 3 nm or more 15 nm or less, more favorably 5 nm or more 10 nm or less. The average thickness of the second underlayer 814B is favorably 7 nm or more and 40 nm or less, more favorably 10 nm or more and 25 nm or less.

### (Magnetic Layer)

The magnetic layer (referred to also as a recording layer) 815 may be a perpendicular magnetic recording layer in which a magnetic material is perpendicularly oriented. From the viewpoint of improving recording density, it is favorable that the magnetic layer 815 is a granular magnetic layer containing a Co alloy. This granular magnetic layer includes ferromagnetic crystal grains containing a Co alloy and non-magnetic grain boundaries (non-magnetic material) surrounding the ferromagnetic crystal grains. More specifically, this granular magnetic layer includes columns (columnar crystals) containing a Co alloy and non-magnetic grain boundaries(oxide such as SiO₂₎ that surround the columns and magnetically separate the columns. In this structure, the magnetic layer 815 having a structure in which the columns are magnetically separated can be formed.

The Co alloy has a hexagonal close-packed (hcp) structure, and the ε-axis thereof is oriented in the perpendicular direction to the film surface (film thickness direction). It is favorable to use a CoCrPt alloy containing at least Co, Cr, and Pt as the Co alloy. The CoCrPt alloy may further include an additive element. Examples of the additive element include one or more elements selected from the group consisting of Ni, Ta, and the like.

The non-magnetic grain boundaries that surround ferromagnetic crystal grains contain a non-magnetic metal material. Here, the metal includes a semimetal. As the non-magnetic metal material, for example, at least one of a metal oxide and a metal nitride can be used, and it is favorable to use a metal oxide from the viewpoint of maintaining the granular structure more stably. Examples of the metal oxide include a metal oxide containing at least one element selected from the group consisting of Si, Cr, Co, Al, Ti, Ta, Zr, Ce, Y, Hf, and the like, and a metal oxide containing at least an Si oxide (i.e., SiO₂₎ is favorable. Specific examples of the metal oxide include SiO₂, Cr₂O₃, CoO, Al₂O₃, TiO₂, Tσ₂O₅, ZrO₂, and HfO₂. Examples of the metal nitride include a metal nitride containing at least one element selected from the group consisting of Si, Cr, Co, Al, Ti, Ta, Zr, Ce, Y, Hf, and the like. Specific examples of the metal nitride include SiN, TiN, and AlN.

It is favorable that the CoCrPt alloy contained in the ferromagnetic crystal grains and the Si oxide contained in the non-magnetic grain boundaries have an average composition represented by the following formula (1). This is because it is possible to realize the saturation magnetization amount Ms capable of suppressing the influence of the demagnetizing field and ensuring sufficient reproduction output, thereby further improving recording and reproduction properties.

$${( {Co}_{x} {Pt}_{y} {Cr}_{100 - x - y} )}_{100 - z} - {( {SiO}_{2} )}_{z} \qquad ( 1 )$$

(however, in the formula (1), x, y, and z are values within the ranges of 69≤X≤75, 10≤y≤16, and 9≤Z≤12.)

Note that the above composition can be obtained as follows. While ion milling the magnetic recording medium 810 from the side of the magnetic layer 815, the depth direction analysis is performed on the magnetic layer 815 by AES to obtain the average composition (average atomic ratio) of Co, Pt, Cr, Si, and O in the film thickness direction.

The average thickness tₘ [nm] of the magnetic layer 815 is favorably 9 nm tₘ 90 nm, more favorably 9 nm tₘ 20 nm, and still more favorably 9 nm≤tₘ≤15 nm. When the average thickness tₘ of the magnetic layer 815 is within the above numerical range, it is possible to improve electromagnetic conversion characteristics.

### (Protective Layer)

The protective layer 816 contains, for example, a carbon material or silicon dioxide(SiO₂₎, and favorably contains a carbon material from the viewpoint of the film strength of the protective layer 816. Examples of the carbon material include graphite, diamond-like carbon (DLC), and diamond.

### (Lubricant Layer)

The lubricant layer 817 includes at least one type of lubricant. The lubricant layer 817 may further include various additives such as a rust inhibitor as necessary. The lubricant has at least two carboxyl groups and one ester bond, and contains at least one carboxylic acid compound represented by the following general formula (1). The lubricant may further include a type of lubricant other than the carboxylic acid compound represented by the following general formula (1).

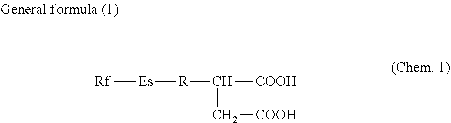

(in the formula, Rf represents an unsubstituted or substituted saturated or unsaturated fluorine-containing hydrocarbon group or hydrocarbon group, Es represents an ester bond, and R represents an unsubstituted or substituted saturated or unsaturated hydrocarbon group, which does not necessarily need to be contained.)

The above carboxylic acid compound is favorably one represented by the following general formula (2) or (3).

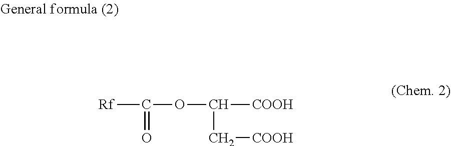

(in the formula, Rf represents an unsubstituted or substituted saturated or unsaturated fluorine-containing hydrocarbon group or hydrocarbon group.)

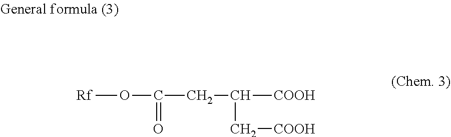

(in the formula, Rf represents an unsubstituted or substituted saturated or unsaturated fluorine-containing hydrocarbon group or hydrocarbon group.)

The lubricant favorably contains one or both of the carboxylic acid compounds represented by the above general formulae (2) and (3).

When a lubricant containing the carboxylic acid compound represented by the general formula (1) is applied to the magnetic layer 815, the protective layer 816, or the like, a lubricating effect is exerted by the cohesive force between fluorine-containing hydrocarbon groups or hydrocarbon groups Rf that are hydrophobic groups. In the case where the Rf group is a fluorine-containing hydrocarbon group, it is favorable that the total number of carbon atoms is 6 to 50 and the total number of carbon atoms of the fluorinated hydrocarbon group is 4 to 20. The Rf group may be, for example, a saturated or unsaturated linear, branched, or cyclic hydrocarbon group, but may be favorably a saturated linear hydrocarbon group.

For example, in the case where the Rf group is a hydrocarbon group, it is favorably a group represented by the following general formula (4).

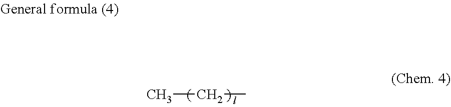

(however, in the general formula (4), 1 represents an integer selected from the range of 8 to 30, more desirably 12 to 20.)

Further, in the case where the Rf groups is a fluorine-containing hydrocarbon group, it is desirably a group represented by the following general formula (5).

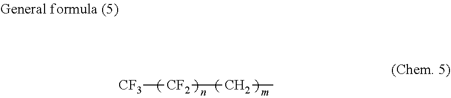

(however. in the general formula (5). m and n each represent an integer independently selected from the following ranges, m=2 to 20, n=3 to 18, more desirable, m=4 to 13, n=3 to 10.)

The fluorinated hydrocarbon group may be concentrated at one location in the molecule as described above, may be dispersed as shown in the following general formula (6), and may be not only —CF₃ or —CF₂— but also —CHF₂, —CHF—, or the like.

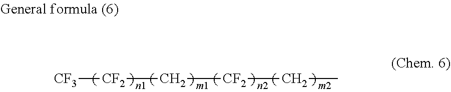

(however, in the general formulae (5) and (6), n1+n2=n, m1+m2=m.)

The reason why the number of carbon atoms is limited as described above in the general formulae (4), (5), and (6) is that when the number of carbon atoms (l or the sum of m and n) forming an alkyl group or a fluorine-containing alkyl group is the above lower limit or more, the length is appropriate, the cohesive force between hydrophobic groups is effectively exerted, a favorable lubricating effect is exerted, and friction/wear durability is improved. Further, when the number of carbon atoms is the above upper limit or less, solubility of a lubricant formed of the above carboxylic acid compound in a solvent is maintained favorably.

In particular, when the Rf groups in the general formulae (1), (2), and (3) contains a fluorine atom, they are effective in reducing the coefficient of friction, improving travelling performance, and the like. However, it is favorable to provide a hydrocarbon group between the fluorine-containing hydrocarbon group and the ester bond to separate the fluorine-containing hydrocarbon group and the ester bond to ensure stability of the ester bond and prevent hydrolysis.

Further, the Rf group may have a fluoroalkylether group or a perfluoropolyether group.

The R group in the general formula(1) does not necessarily need to be contained, but is favorably a hydrocarbon chain having a relatively small number of carbon atoms if it is contained.

Further, the Rf group, or R group may contain one or more elements selected from the group consisting of nitrogen, oxygen, sulfur, phosphorus, and halogen as a constituent element, and may further have a hydroxyl group, a carboxyl group, a carbonyl group, an amino group, an ester bond, and the like in addition to the above-mentioned functional groups.

Specifically, the carboxylic acid compound represented by the general formula (1) is favorably at least one of the following compounds. That is, the lubricant favorably contains at least one of the following compound.
CF₃ (CF₂)₇ (CH₂)₁₀COOCH (COOH) CH₂COOH
CF₃ (CF₂)₃ (CH₂)₁₀COOCH (COOH) CH₂COOH
C₁₇H₃₅COOCH (COOH) CH₂COOH
CF₃ (CF₂)₇ (CH₂)₂OCOCH₂CH (C₁₈H₃₇₎ COOCH (COOH) CH₂COOH
CF₃ (CF₂)₇COOCH (COOH) CH₂COOH
CHF₂ (CF₂)₇COOCH (COOH) CH₂COOH
CF₃ (CF₂)₇ (CH₂)₂OCOCH₂CH (COOH) CH₂COOH
CF₃ (CF₂)₇ (CH₂)₆OCOCH₂CH (COOH) CH₂COOH
CF₃ (CF₂)₇ (CH₂)₁₁OCOCH₂CH (COOH) CH₂COOH
CF₃ (CF₂)₃ (CH₂)₆OCOCH₂CH (COOH) CH₂COOH
C₁₈H₃₇OCOCH₂CH (COOH) CH₂COOH
CF₃ (CF₂)₇ (CH₂)₄COOCH (COOH) CH₂COOH
CF₃ (CF₂)₃ (CH₂)₄COOCH (COOH) CH₂COOH
CF₃ (CF₂)₃ (CH₂)₇COOCH (COOH) CH₂COOH
CF₃ (CF₂)₉ (CH₂)₁₀COOCH (COOH) CH₂COOH
CF₃ (CF₂)₇ (CH₂)₁₂COOCH (COOH) CH₂COOH
CF₃ (CF₂)₅ (CH₂)₁₀COOCH (COOH) CH₂COOH
CF₃ (CF₂)₇CH (C₉H₁₉₎ CH₂CH═CH (CH₂)₇COOCH (COOH) CH₂COOH
CF₃ (CF₂)₇CH (C₆H₁₃₎ (CH₂)₇COOCH (COOH) CH₂COOH
CH₃ (CH₂)₃ (CH₂CH₂CH (CH₂CH₂ (CF₂)₉CF₃))₂ (CH₂)₇COOCH (COOH) CH₂COO H

The carboxylic acid compound represented by the general formula (1) is soluble in non-fluorine solvents that have a small impact on the environment, and has the advantage that operations such as application, immersion, and spraying can be performed using general-purpose solvents such as a hydrocarbon solvent, a ketone solvent, an alcohol solvent, and an ester solvent. Specifically, examples of the general-purpose solvent include hexane, heptane, octane, decane, dodecane, benzene, toluene, xylene, cyclohexane, methyl ethyl ketone, methylisobutylketone, methanol, ethanol, isopropanol, diethylether, tetrahydrofuran, dioxane, and cyclohexanone.

In the case where the protective layer 816 contains a carbon material, when the above carboxylic acid compound is applied onto the protective layer 816 as a lubricant, two carboxyl groups and at least one ester bond group, which are polar groups of the lubricant molecules, are adsorbed on the protective layer 816, and the lubricant layer 817 having a particularly favorable durability can be formed by the cohesive force between hydrophobic groups.

Note that the lubricant does not necessarily need to be held as the lubricant layer 817 on the front surface of the magnetic recording medium 810 as described above, and may be included and held in a layer such as the magnetic layer 815 and the protective layer 816 forming the magnetic recording medium 810.

### (Back Layer)

The description regarding the back layer 14 in the first embodiment applies to the back layer 818.

### (3) Physical Properties and Structure

The description regarding the physical properties and structure described in the above (3) of 2. also applies to the second embodiment. Description of the physical properties and structure of the magnetic recording medium according to the second embodiment is omitted except for points different from those in the first embodiment. The average thickness of the base layer 811 is measured in the same manner as that for the base layer 11 in the first embodiment except that the layers of each sample other than the base layer are removed using a solvent such as MEK (methyl ethyl ketone) and dilute hydrochloric acid and then washed with pure water.

### (4) Configuration of Sputtering Apparatus

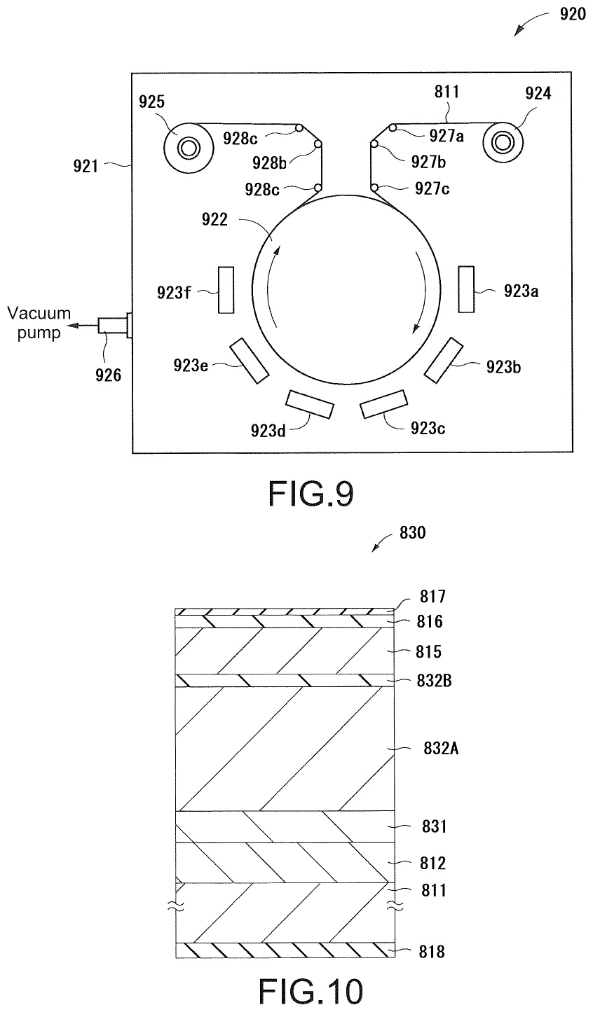

An example of a configuration of a sputtering apparatus 920 to be used for producing the magnetic recording medium 810 will be described below with reference to FIG. 9. This sputtering apparatus 920 is a continuous winding sputtering apparatus to be used for depositing the SUL 812, the first seed layer 813A, the second seed layer 813B, the first underlayer 814A, the second underlayer 814B, and the magnetic layer 815, and includes a deposition chamber 921, a drum 922 that is a metal can (rotating body), cathodes 923a to 923f, a supply reel 924, a take-up reel 925, and a plurality of guide rollers 927a to 927c and 928a to 928c as shown in the figure. Although the sputtering apparatus 920 is, for example, an apparatus using a DC (direct current) magnetron sputtering method, the sputtering method is not limited to this method.

The deposition chamber 921 is connected to a vacuum pump (not shown) via an exhaust port 926, and the atmosphere in the deposition chamber 921 is set to a predetermined degree of vacuum by this vacuum pump. Inside the deposition chamber 921, the drum 922, the supply reel 924, and the take-up reel 925 that are configured to be rotatable are disposed. Inside the deposition chamber 921, the plurality of guide rollers 927a to 927c for guiding conveyance of the base layer 811 between the supply reel 924 and the drum 922 is provided, and the plurality of guide rollers 928a to 928c for guiding conveyance of the base layer 811 between the drum 922 and the take-up reel 925 is provided. During sputtering, the base layer 811 unwound from the supply reel 924 is wound up by the take-up reel 925 via the guide rollers 927a to 927c, the drum 922, and the guide rollers 928a to 928c. The drum 922 has a columnar shape, and the long base layer 811 is conveyed along the columnar circumferential surface of the drum 922. The drum 922 is provided with a cooling mechanism (not shown) and is cooled to, for example, approximately −20° C. during sputtering. Inside the deposition chamber 921, the plurality of cathodes 923a to 923f is disposed to face the circumferential surface of the drum 922. Targets are set for the respective cathodes 923a to 923f. Specifically, targets for depositing the SUL 812, the first seed layer 813A, the second seed layer 813B, the first underlayer 814A, the second underlayer 814B, and the magnetic layer 815 are respectively set for the cathodes 923a, 923b, 923c, 923d, 923e, and 923f. A plurality of types of films, i.e., the SUL 812, the first seed layer 813A, the second seed layer 813B, the first underlayer 814A, the second underlayer 814B, and the magnetic layer 815 are simultaneously deposited by these cathodes 923a to 923f.

In the sputtering apparatus 920 having the above-mentioned configuration, it is possible to successively deposit the SUL 812, the first seed layer 813A, the second seed layer 813B, the first underlayer 814A, the second underlayer 814B, and the magnetic layer 815 by a Roll-to-Roll method.

### (5) Method of Producing Magnetic Recording Medium

The magnetic recording medium 810 can be produced, for example, as follows.

First, the SUL 812, the first seed layer 813A, the second seed layer 813B, the first underlayer 814A, the second underlayer 814B, and the magnetic layer 815 are sequentially deposited on the front surface of the base layer 811 using the sputtering apparatus 920 shown in FIG. 9. Specifically, the deposition is performed as follows. First, the deposition chamber 921 is evacuated to a predetermined pressure. After that, the targets set on the cathodes 923a to 923f are sputtered while introducing a process gas such as an Ar gas into the deposition chamber 921. As a result, the SUL 812, the first seed layer 813A, the second seed layer 813B, the first underlayer 814A, the second underlayer 814B, and the magnetic layer 815 are sequentially deposited the front surface of the travelling base layer 811.

The atmosphere in the deposition chamber 921 during sputtering is set to, for example, approximately 1×10⁻⁵ Pa to 5×10⁻⁵ Pa. The film thicknesses and properties of the SUL 812, the first seed layer 813A, the second seed layer 813B, the first underlayer 814A, the second underlayer 814B, and the magnetic layer 815 can be controlled by adjusting the tape line speed for winding up the base layer 811, the pressure of process gas such as an Ar gas to be introduced during sputtering (sputter gas pressure), input power, and the like.

Next, the protective layer 816 is deposited on the magnetic layer 815. As a deposition method of the protective layer 816, for example, a chemical vapor deposition (CVD) method or physical vapor deposition (PVD) method can be used.

Next, a binder, inorganic particles, a lubricant, and the like are kneaded and dispersed in a solvent to prepare a paint for depositing a back layer. Next, the paint for depositing a back layer is applied onto the back surface of the base layer 811 and dried to deposit the back layer 818 on the back surface of the base layer 811.

Next, for example, a lubricant is applied onto the protective layer 816 to deposit the lubricant layer 817. As the method of applying a lubricant, for example, various application methods such as gravure coating and dip coating can be used. Next, the magnetic recording medium 810 is cut into a predetermined width as necessary. In this way, the magnetic recording medium 810 shown in FIG. 8 is obtained.

### (6) Modified Example

The magnetic recording medium 810 may further include an underlayer between the base layer 811 and the SUL 812. Since the SUL 812 has an amorphous state, it does not play a role in promoting epitaxial growth of the layer formed on the SUL 812, but is required not to disturb the crystal orientation of the first and second underlayers 814A and 814B formed on the SUL 812. For this purpose, it is favorable that the soft magnetic material has a fine structure that does not form a column. However, in the case where the influence of release of gas such as moisture from the base layer 811 is large, there is a possibility that the soft magnetic material becomes coarse and the crystal orientation of the first and second underlayers 814A and 814B formed on the SUL 812 is disturbed. In order to suppress the influence of release of gas such as moisture from the base layer 811, it is favorable to provide an underlayer that contains an alloy including Ti and Cr and has an amorphous state between the base layer 811 and the SUL 812, as described above. As a specific configuration of this underlayer, a configuration similar to that of the first seed layer 813A in the second embodiment can be adopted.

The magnetic recording medium 810 does not necessarily need to include at least one layer of the second seed layer 813B or the second underlayer 814B. However, from the viewpoint of improving SNR, it is more favorable that the magnetic recording medium 810 includes both the second seed layer 813B and the second underlayer 814B.

The magnetic recording medium 810 may include an APC-SUL (Antiparallel Coupled SUL) instead of the single layer of SUL.

### (7) Another Example of Magnetic Recording Medium

### (Configuration of Another Example of Magnetic Recording Medium)

The magnetic recording medium according to this embodiment may be configured like a magnetic recording medium 830 described below. As shown in FIG. 10, the magnetic recording medium 830 includes the base layer 811, the SUL 812, a seed layer 831, a first underlayer 832A, a second underlayer 832B, and the magnetic layer 815. Note that regarding description of the magnetic recording medium 830, the same configuration as that of the magnetic recording medium 810 is denoted by the same reference symbol and description thereof is omitted.

The SUL 812, the seed layer 831, and the first and second underlayers 832A and 832B are provided between one main surface of the base layer 811 and the magnetic layer 815, and are stacked in the order of the SUL 812, the seed layer 831, the first underlayer 832A, and the second underlayer 832B from the base layer 811 toward the magnetic layer 815.

### (Seed Layer)

The seed layer 831 contains Cr, Ni, and Fe and has a face-centered cubic lattice (fcc) structure, and the (111) plane of this face-centered cubic structure is preferentially oriented so as to be parallel to the front surface of the base layer 811. Here, the preferential orientation means a state in which the diffraction peak intensity from the(111) plane of the face-centered cubic lattice structure in the θ-2θ scan of X-ray diffraction is larger than the diffraction peaks from other crystal planes or a state in which only the diffraction peak intensity from the(111) plane of the face-centered cubic lattice structure in the θ-2θ scan of X-ray diffraction is observed.

From the viewpoint of improving SNR, the intensity ratio of X-ray diffraction of the seed layer 831 is favorably 60 cps/nm or more, more favorably 70 cps/nm or more, and still more favorably 80 cps/nm or more. Here, the intensity ratio of X-ray diffraction of the seed layer 831 is a value obtained by dividing an intensity I (cps) of X-ray diffraction of the seed layer 831 by an average thickness D (nm) of the seed layer 831 (I/D (cps/nm)).

It is favorable that Cr, Ni, and Fe contained in the seed layer 831 have an average composition represented by the following formula (2).

Cr_{X}(Ni_{Y}Fe_{100-Y})_{100-X} (2)
(however, in the formula (2), X is in the range of 10≤X≤45 and Y is within the range of 60≤Y≤90.)

When X is within the above range, the (111) orientation of the face-centered cubic lattice structure of Cr, Ni, and Fe is improved, and it is possible to obtain a more favorable SNR. Similarly, when Y is within the above range, the (111) orientation of the face-centered cubic lattice structure of Cr, Ni, and Fe is improved, and it is possible to obtain a more favorable SNR.

The average thickness of the seed layer 831 is favorably 5 nm or more and 40 nm or less. By setting the average thickness of the seed layer 831 to this range, the (111) orientation of the face-centered cubic lattice structure of Cr, Ni, and Fe is improved, and it is possible to obtain a more favorable SNR. Note that the average thickness of the seed layer 831 is obtained in the same manner as that for the magnetic layer 13 in the first embodiment. However, the magnification of the TEM image is appropriately adjusted in accordance with the thickness of the seed layer 831.

### (First and Second Underlayers)

The first underlayer 832A contains Co and O having a face-centered cubic lattice structure and has a column (columnar crystal) structure. In the first underlayer 832A containing Co and O, effects (functions) substantially similar to those of the second underlayer 832B containing Ru can be achieved. The concentration ratio of the average atomic concentration of O to the average atomic concentration of Co ((average atomic concentration of O)/(average atomic concentration of Co)) is one or more. When the concentration ratio is one or more, the effect of providing the first underlayer 832A is improved, and it is possible to obtain a more favorable SNR.

From the viewpoint of improving SNR, the column structure is favorably inclined. The direction of the inclination is favorably the longitudinal direction of the long magnetic recording medium 830. The reason why the longitudinal direction is favorable is as follows. The magnetic recording medium 830 is a so-called linear recording magnetic recording medium, and the recording track is parallel to the longitudinal direction of the magnetic recording medium 830. Further, the magnetic recording medium 830 is also a so-called perpendicular magnetic recording medium, and the crystal orientation axis of the magnetic layer 815 is the perpendicular direction from the viewpoint of recording properties. However, the crystal orientation axis of the magnetic layer 815 is inclined due to the inclination of the column structure of the first underlayer 832A. In the magnetic recording medium 830 for linear recording, the configuration in which the crystal orientation axis of the magnetic layer 815 is inclined in the longitudinal direction of the magnetic recording medium 830 due to the relationship with the head magnetic field during recording is capable of reducing the influence on recording properties due to the inclination of the crystal orientation axis as compared with the configuration in which the crystal orientation axis of the magnetic layer 815 is inclined in the width direction of the magnetic recording medium 830. In order to cause the crystal orientation axis of the magnetic layer 815 to be inclined in the longitudinal direction of the magnetic recording medium 830, it is favorable that the inclination direction of the column structure of the first underlayer 832A is the longitudinal direction of the magnetic recording medium 830 as described above.

The inclination angle of the column structure is favorably greater than 0° and 60° or less. In the range where the inclination angle is greater than 0° and 60° or less, the tip shape of the column included in the first underlayer 832A changes greatly and becomes substantially triangular mountain-shaped, and thus, there is a tendency that the effects of the granular structure are enhanced, noise is reduced, and SNR is improved. Meanwhile, when the inclination angle exceeds 60°, the tip shape of the column included in the first underlayer 832A changes little and is unlikely to become substantially triangular mountain-shaped, and thus, there is a tendency that the noise reduction effect is weakened.

The average particle size of the column structure is 3 nm or more and 13 nm or less. When the average particle size is less than 3 nm, the average particle size of the column structure included in the magnetic layer 815 becomes small, and thus, there is a possibility that the recording retention ability is reduced in the case of the current magnetic material. Meanwhile, when the average particle size is 13 nm or less, noise is suppressed, and it is possible to obtain a more favorable SNR.

The average thickness of the first underlayer 832A is favorably 10 nm or more and 150 nm or less. When the average thickness of the first underlayer 832A is 10 nm or more, the (111) orientation of the face-centered cubic lattice structure of the first underlayer 832A is improved, and it is possible to obtain a more favorable SNR. Meanwhile, when the average thickness of the first underlayer 832A is 150 nm or less, it is possible to prevent the particle size of the column from increasing. Therefore, it is possible to suppress noise and obtain a more favorable SNR. Note that the average thickness of the first underlayer 832A is obtained in the same manner as that for the magnetic layer 13 in the first embodiment. However, the magnification of the TEM image is appropriately adjusted in accordance with the thickness of the first underlayer 832A.

It is favorable that the second underlayer 832B has a crystal structure similar to that of the magnetic layer 815. In the case where the magnetic layer 815 contains a Co alloy, the second underlayer 832B contains a material having a hexagonal close-packed (hcp) structure similar to that of the Co alloy, and it is favorable that the ε-axis of the structure is oriented in the perpendicular direction to the film surface (i.e., the film thickness direction). This is because the orientation of the magnetic layer 815 can be improved and the matching of lattice constant between the second underlayer 832B and the magnetic layer 815 can be made relatively favorable. As the material having a hexagonal close-packed structure, it is favorable to use a material containing Ru, specifically Ru alone or an Ru alloy. Examples of the Ru alloy include an Ru alloy oxide such as Ru—SiO₂, Ru—TiO₂, and Ru—ZrO₂.

The average thickness of the second underlayer 832B may be thinner than that of an underlayer in a general magnetic recording medium (e.g., underlayer containing Ru), and can be, for example, 1 nm or more and 5 nm or less. Since the seed layer 831 and the first underlayer 832A having the above-mentioned configurations are provided below the second underlayer 832B, a favorable SNR can be obtained even if the average thickness of the second underlayer 832B is thin as described above. Note that the average thickness of the second underlayer 832B is obtained in the same manner as that for the magnetic layer 13 in the first embodiment. However, the magnification of the TEM image is appropriately adjusted in accordance with the thickness of the second underlayer 832B.

The magnetic recording medium 830 includes the seed layer 831 and the first underlayer 832A between the base layer 811 and the second underlayer 832B. The seed layer 831 contains Cr, Ni, and Fe and has a face-centered cubic lattice structure, and the (111) plane of this face-centered cubic structure is preferentially oriented so as to be parallel to the front surface of the base layer 811. The first underlayer 832A contains Co and O and has a column structure in which the ratio of the average atomic concentration of O to the average atomic concentration of Co is 1 or more and the average particle size is 3 nm or more and 13 nm or less. As a result, it is possible to realize the magnetic layer 815 that has favorable crystal orientation and high coercive force by reducing the thickness of the second underlayer 832B without using Ru that is an expensive material as much as possible.

Ru contained in the second underlayer 832B has the same hexagonal close-packed lattice structure as that of Co that is the main component of the magnetic layer 815. For this reason, Ru has the effect of simultaneously improving the crystal orientation of the magnetic layer 815 and promoting the granularity. Further, in order to further improve the crystal orientation of Ru contained in the second underlayer 832B, the first underlayer 832A and the seed layer 831 are provided below the second underlayer 832B. In the magnetic recording medium 830, effects (functions) substantially similar to those of the second underlayer 832B containing Ru are realized by the first underlayer 832A containing inexpensive CoO having a face-centered cubic lattice structure. For this reason, the thickness of the second underlayer 832B can be reduced. Further, in order to improve the crystal orientation of the first underlayer 832A, the seed layer 831 containing Cr, Ni, and Fe is provided.

### 4. Third Embodiment

### (1) Embodiment of Magnetic Recording Cartridge

### [Configuration of Cartridge]

The present technology also provides a magnetic recording cartridge (referred to also as a tape cartridge) that includes the magnetic recording medium according to the present technology. In the magnetic recording cartridge, the magnetic recording medium may be wound around, for example, a reel. The magnetic recording cartridge may include, for example, a communication unit that communicates with a recording/reproduction apparatus, a storage unit, and a control unit that stores the information received from the recording/reproduction apparatus via the communication unit in the storage unit, reads the information from the storage unit in accordance with a request from the recording/reproduction apparatus, and transmits the read information to the recording/reproduction apparatus via the communication unit. The information may include adjustment information for adjusting tension to be applied to the magnetic recording medium in the longitudinal direction.

An example of a configuration of the magnetic recording cartridge 10A that includes a magnetic recording medium T having the above-mentioned configuration will be described with reference to FIG. 2.

FIG. 2 is an exploded perspective view showing an example of the configuration of the magnetic recording cartridge 10A. The magnetic recording cartridge 10A is a magnetic recording cartridge conforming to the LTO (Linear Tape-Open) standard, and includes, inside the cartridge case 10B including a lower shell 212A and an upper shell 212B, the reel 10C on which a magnetic tape (tape-shaped magnetic recording medium) T is wound, a reel lock 214 and a reel spring 215 for locking rotation of the reel 10C, a spider 216 for releasing the locked state of the reel 10C, a slide door 217 that opens and closes a tape outlet 212C provided in the cartridge case 10B across the lower shell 212A and the upper shell 212B, a door spring 218 that biases the slide door 217 to the closed position of the tape outlet 212C, a write protector 219 for preventing erroneous erasure, and a cartridge memory 211. The reel 10C has a substantially disk shape having an opening at its center, and includes a reel hub 213A and a flange 213B formed of a hard material such as plastic. The leader tape LT is connected to one end portion of the magnetic tape T. A leader pin 220 is provided at the tip of the leader tape LT.

The cartridge memory 211 is provided in the vicinity of one corner portion of the magnetic recording cartridge 10A. The cartridge memory 211 faces a reader/writer (not shown) of a recording/reproduction apparatus 80 while the magnetic recording cartridge 10A is loaded into the recording/reproduction apparatus 80. The cartridge memory 211 communicates with the recording/reproduction apparatus 30, specifically, a reader/writer (not shown), using a radio communication standard conforming to the LTO standard.

### [Configuration of Cartridge Memory]

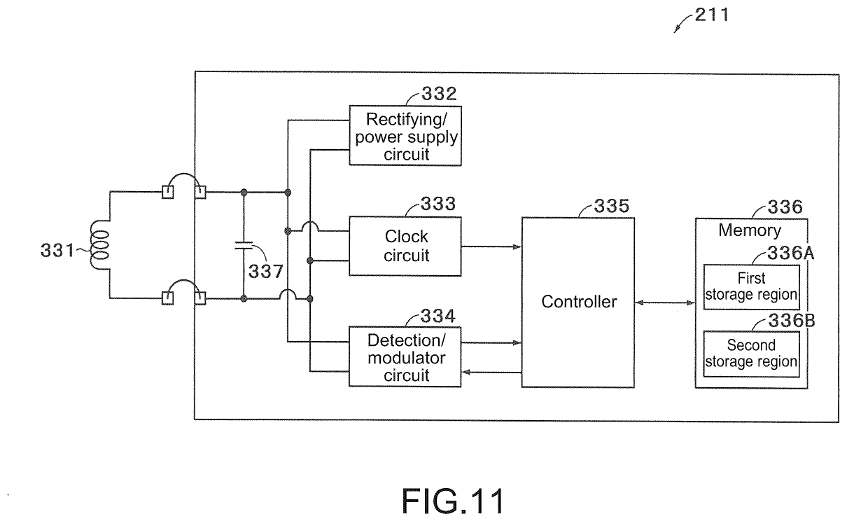

An example of a configuration of the cartridge memory 211 will be described with reference to FIG. 11. This figure is a block diagram showing an example of a configuration of the cartridge memory 211. The cartridge memory 211 includes an antenna coil (communication unit) 331 for communicating with a reader/writer (not shown) in a specified communication standard, a rectifying/power supply circuit 332 that generates and rectifies power from radio waves received by the antenna coil 331 using induced electromotive force to generate a power source, a clock circuit 333 that generates clocks using induced electromotive force similarly from radio waves received by the antenna coil 331, a detection/modulator circuit 334 for detecting radio waves received by the antenna coil 331 and modulating signals transmitted by the antenna coil 331, a controller (control unit) 335 including a logical circuit and the like for discriminating commands and data from digital signals extracted from the detection/modulator circuit 334 and processing the commands and data, and a memory (storage unit) 336 that stores information. Further, the cartridge memory 211 includes a capacitor 337 connected in parallel to the antenna coil 331, and the antenna coil 331 and the capacitor 337 constitute a resonant circuit.

The memory 336 stores information relating to the magnetic recording cartridge 10A, and the like. The memory 336 is a non-volatile memory (NVM). The storage capacity of the memory 336 is favorably approximately 32 KB or more. For example, in the case where the magnetic recording cartridge 10A conforms to an LTO format standard in the next generation and subsequent generations, the memory 336 has the storage capacity of approximately 32 KB.

The memory 336 has a first storage region 336A and a second storage region 336B. The first storage region 336A corresponds to a storage region of a cartridge memory of the LTO standard before LTO8 (hereinafter, referred to as “existing cartridge memory”.), and is a region for storing information conforming to the LTO standard before LTO8. Examples of the information conforming to the LTO standard before LTO8 include production information (e.g., the unique number of the magnetic recording cartridge 10A) and usage history (e.g., the number of tape withdrawals (Thread Count)).

The second storage region 336B corresponds to an extended storage region for the storage region of the existing cartridge memory. The second storage region 336B is a region for storing additional information. Here, the additional information means information relating to the magnetic recording cartridge 10A, which is not specified in the LTO standard before LTO8. Examples of the additional information include, but not limited to, tension adjustment information, management ledger data, Index information, and thumbnail information of video stored in the magnetic tape T. The tension adjustment information includes a distance between adjacent servo bands (distance between servo patterns recorded on adjacent servo bands) during data recording on the magnetic tape T. The distance between adjacent servo bands is an example of width-related information relating to the width of the magnetic tape T. The details of the distance between servo bands will be described below. In the following description, the information stored in the first storage region 336A is referred to as “first information” and the information stored in the second storage region 336B is referred to as “second information” in some cases.

The memory 336 may include a plurality of banks. In this case, the first storage region 336A may be configured by some of the plurality of banks, and the second storage region 336B may be configured by the remaining banks. Specifically, for example, in the case where the magnetic recording cartridge 10A conforms to the LTO format standard in the next generation and subsequent generations, the memory 336 may include two banks having the storage capacity or approximately 16 KB, the first storage region 336A may be configured by one of the two banks, and the second storage region 336B may be configured by the other bank.

The antenna coil 331 induces an induced voltage by electromagnetic induction. The controller 335 communicates with the recording/reproduction apparatus 80 in a specified communication standard via the antenna coil 331. Specifically, for example, mutual authentication, transmission and reception of commands, exchanging data, and the like are performed.

The controller 335 stores the information received from the recording/reproduction apparatus 80 via the antenna coil 331 in the memory 336. The controller 335 reads the information from the memory 336 in accordance with a request from the recording/reproduction apparatus 80, and transmits the read information to the recording/reproduction apparatus 80 via the antenna coil 331.

### (2) Modified Example of Magnetic Recording Cartridge

### [Configuration of Cartridge]

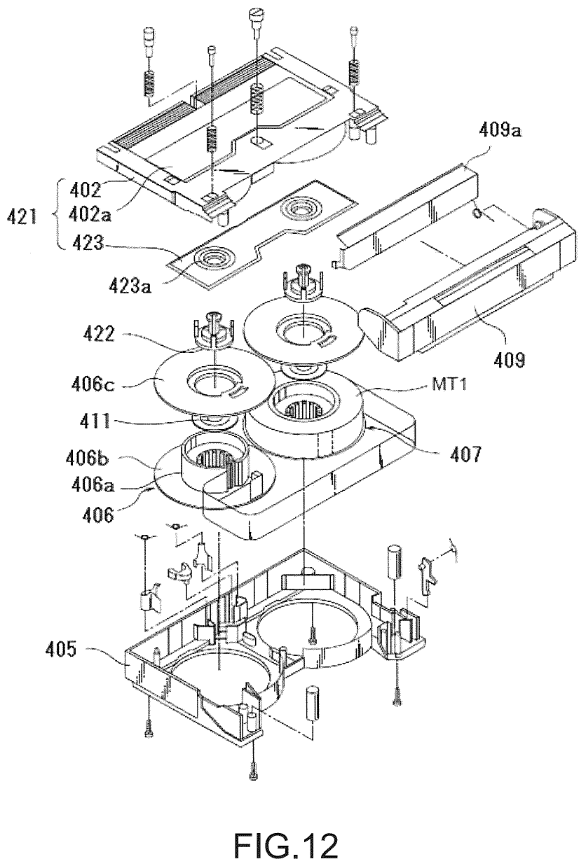

Although the case where the magnetic tape cartridge is a one-reel type cartridge has been described in the above-mentioned one embodiment of the magnetic recording cartridge, the magnetic recording cartridge according to the present technology may be a two-reel type cartridge. That is, the magnetic recording cartridge according to the present technology may include one or a plurality (e.g., two) of reels by which the magnetic tape is wound up. An example of the magnetic recording cartridge that includes two reels according to the present technology will be described below with reference to FIG. 12.

FIG. 12 is an exploded perspective view showing an example of a configuration of a two-reel type cartridge 421. The cartridge 421 includes an upper half 402 formed of a synthetic resin, a transparent window member 423 that is fitted into and fixed to a window 402a opened on the upper surface of the upper half 402, a reel holder 422 that is fixed to the inside of the upper half 402 and prevents reels 406 and 407 from floating, a lower half 405 corresponding to the upper half 402, the reels 406 and 407 housed in a space formed by combining the upper half 402 and the lower half 405, a magnetic tape MT1 wound around the reels 406 and 407, a front lid 409 that closes the front-side opening formed by combining the upper half 402 and the lower half 405, and a back lid 409A that protects the magnetic tape MT1 exposed in this front-side opening.

The reel 406 includes a lower flange 406b that includes a cylindrical hub portion 406a in the center around which the magnetic tape MT1 is wound, an upper flange 406c having substantially the same size as that of the lower flange 406b, and a reel plate 411 sandwiched between the hub portion 406a and the upper flange 406c. The reel 407 has a configuration similar to that of the reel 406.

The window member 423 is provided with mounting holes 423a for assembling the reel holders 422 that are reel holding means for preventing the reels 406 and 407 from floating at the positions corresponding to the reels. The magnetic tape MT1 is similar to the magnetic tape T in the first embodiment.

It should be noted that the present technology may also take the following configurations.
[1] A magnetic recording medium, in which
   an average value A_{(E″)} of loss elastic moduli E″ in a temperature range of 60° C. to 65° C. when dynamic mechanical analysis is performed on the magnetic recording medium at a frequency of 10 Hz and a heating rate of 2° C./min is 0.06 GPa or less, and
   an average height Rpk of protruding peaks measured using a non-contact profilometer using optical interference is 2.4 nm or less.
[2] The magnetic recording medium according to [1], in which
   an average value A_{(E′)} of storage elastic moduli E′ in a temperature range of 60° C. to 65° C. when the dynamic mechanical analysis is performed is 6 GPa or less.
[3] The magnetic recording medium according to [1] or [2], in which
   an average value A_{(Tanδ)} of Tanδs (loss elastic modulus E″/storage elastic modulus E′) in a temperature range of 60° C. to 65° C. when the dynamic mechanical analysis is performed is 0.017 or less.
[4] The magnetic recording medium according to any one of [1] to [3], in which
   a base layer included in the magnetic recording medium has an average thickness t_{Base} of 4.5 μm or less.
[5] The magnetic recording medium according to any one of [1] to [4], in which
   an average thickness t_{T} of the magnetic recording medium is 5.3 μm or less.
[6] The magnetic recording medium according to any one of [1] to [5], in which
   a stiffness S of the magnetic recording medium is 1.4 mgf/μm or less.
[7] The magnetic recording medium according to any one of [1] to [6], in which
   the average value A_{(E″)} of loss elastic moduli E″ in a temperature range of 60° C. to 65° C. when the dynamic mechanical analysis is performed is 0.05 GPa or less.
[8] The magnetic recording medium according to any one of [1] to [7], in which
   the average value A_{(E″)} of loss elastic moduli E″ in a temperature range of 60° C. to 65° C. when the dynamic mechanical analysis is performed is 0.04 GPa or less.
[9] The magnetic recording medium according to any one of [1] to [8], in which
   the average height Rpk of protruding peaks is 2.3 nm or less.
[10] The magnetic recording medium according to any one of [1] to [9], in which
   the average height Rpk of protruding peaks is 2.2 nm or less.
[11] The magnetic recording medium according to any one of [1] to [10], in which
   an average value A_{(Tanδ)} of Tanδs when the dynamic mechanical analysis is performed is 0.016 or less.
[12] The magnetic recording medium according to any one of [1] to [11], in which
   an average value A_{(Tanδ)} of Tanδs when the dynamic mechanical analysis is performed is 0.015 or less.
[13] The magnetic recording medium according to any one of [1] to [12], which has
   a width variation ΔW₄₀ₕ when a weight of 0.55 N is applied in a longitudinal direction for 40 hours in an environment of a temperature of 65° C. and a humidity of 40% satisfies a relationship of −600 ppm≤ΔW₄₀ₕ.
[14] The magnetic recording medium according to any one of [1] to [13], including
   a magnetic layer that contains a magnetic powder.
[15] The magnetic recording medium according to any one of [1] to [13], which is a vacuum thin-film recording medium.
[16] A magnetic recording cartridge, including:
   the magnetic recording medium according to any one of [1] to [15] housed in a case while being wound around a reel.

### 5. Examples

The present technology will be specifically described by way of Examples, but the present technology is not limited to only these Examples. Note that values of various parameters appearing in this Example are obtained by the measurement method described above, unless otherwise specified.

Magnetic tapes were obtained as described in the following Examples 1 to 4 and Comparative Examples 1 to 4.

### Example 1

### (Process of Preparing Coating Material for Forming Magnetic Layer)

A coating material for forming a magnetic layer was prepared as follows. First, a first composition blended as shown below was kneaded by an extruder. Next, the kneaded first composition and a second composition blended as shown below were added to a stirring tank including a dispersion device for premixing. Subsequently, dyno mill mixing was further performed and filter treatment was performed to prepare a coating material for forming a magnetic layer.

### (First Composition)

Barium ferrite (BaFe₁₂O₁₉₎ magnetic powder (hexagonal plate shape, average aspect ratio 3.0, average particle volume 1600 nm³⁾: 100 parts by mass
Vinyl chloride resin (cyclohexanone solution 30 mass %): 50 parts by mass
(degree of polymerization 300, Mn=10000, containing OSO₃K=0.07 mmol/g, secondary OH=0.3 mmol/g as polar groups.)
Aluminum oxide powder: 5 parts by mass (α-Al₂O₃, average particle size 0.1 μm)

### (Second Composition)

Carbon black: 2 parts by mass (manufactured by Tokai Carbon Co., Ltd., product name: SEAST TA)
Polyurethane resin (resin solution: blending amount of polyurethane resin 30 mass %, blending amount of cyclohexanone 70 mass %): 5.56 parts by mass
(polyurethane resin: number average molecular weight Mn=25000, Tg 110° C.)
n-butyl stearate: 2 parts by mass
Methyl ethyl ketone: 121.3 parts by mass
Toluene: 121.3 parts by mass
Cyclohexanone: 60.7 parts by mass

Finally, a polyisocyanate (product name: Coronate L, manufactured by TOSOH CORPORATION): 3.3 parts by mass and stearic acid: 2 parts by mass were added as curing agents to the coating material for forming a magnetic layer prepared as described above.

### (Process of Preparing Coating Material for Forming Underlayer)

A coating material for forming an underlayer was prepared as follows. First, a third composition blended as shown below was kneaded by an extruder. Next, the kneaded third composition and a fourth composition blended as shown below were added to a stirring tank including a dispersion device for premixing. Subsequently, dyno mill mixing was further performed and filter treatment was performed to prepare a coating material for forming an underlayer.

### (Third Composition)

Acicular iron oxide powder: 100 parts by mass
(α-Fe₂O₃, average major axis length 0.12 μm)
Vinyl chloride resin (cyclohexanone solution 30 mass %): 46 parts by mass
(degree of polymerization 300, Mn=10000, containing OSO₃K=0.07 mmol/g and secondary OH=0.3 mmol/g as polar groups.)
(average particle size 20 nm)

### (Fourth Composition)

Carbon black: 25 parts by mass
Polyurethane resin (resin solution: blending amount of polyurethane resin 30 mass %, blending amount of cyclohexanone 70 mass %): 36 parts by mass
(polyurethane resin: number average molecular weight Mn=25000, Tg 110° C.)
n-butyl stearate: 2 parts by mass
Methyl ethyl ketone: 108.2 parts by mass
Toluene: 108.2 parts by mass
Cyclohexanone: 18.5 parts by mass

Finally, a polyisocyanate (product name: Coronate L, manufactured by TOSOH CORPORATION): 2.49 parts by mass and stearic acid: 2 parts by mass were added as curing agents to the coating material for forming an underlayer prepared as described above.

### (Process of Preparing Coating Material for Forming Back Layer)

A coating material for forming a back layer was prepared as follows. The following raw materials were mixed in a stirring tank including a dispersion device, and filter treatment was performed to prepare a coating material for forming a back layer.

Carbon black (manufactured by ASAHI CARBON CO., LTD., product name: #80): 100 parts by mass
Polyester polyurethane: 100 parts by mass
(manufactured by Nippon Polyurethane Co., Ltd., product name: N-2304)
Methyl ethyl ketone: 500 parts by mass
Toluene: 400 parts by mass
Cyclohexanone: 100 parts by mass
Polyisocyanate (product name: Coronate L, manufactured by TOSOH CORPORATION): 10 parts by mass

### (Deposition Process)

A magnetic tape was prepared as described below using the paints prepared as described above.

First, a long PEEK film (base film) having an average thickness of 4.0 μm was prepared as a support that is to be used as a base layer of a magnetic tape. Next, the coating material for forming an underlayer was applied onto one main surface of the PEEK film and dried to form an underlayer on the one main surface of the PEEK film such that the average thickness when the final product was obtained was 820 nm. Next, the coating material for forming a magnetic layer was applied onto the underlayer and dried to form a magnetic layer on the underlayer such that the average thickness when the final product was obtained was 80 nm. Further, perpendicular orientation treatment was performed on the magnetic layer using a solenoid coil.

Subsequently, the coating material for forming a back layer was applied onto the other main surface of the PEEK film on which the underlayer and the magnetic layer were formed and dried to form a back layer such that the average thickness when the final product was obtained was 0.3 μm. Then, curing treatment was performed on the PEEK film on which the underlayer, the magnetic layer, and the back layer were formed. After that, calendaring was performed to smooth the front surface of the magnetic layer.

### (Cutting Process)

The magnetic tape obtained as described above was cut into a ½ inch (12.65 mm) width. As a result, a long magnetic tape was obtained.

The magnetic tape having a width of ½ inch was wound around a reel provided in a cartridge case to obtain a magnetic recording cartridge.

A servo signal was recorded on the magnetic tape by a servo track writer. The servo signal includes an array of magnetic patterns having the inverted V shape. Two or more arrays of the magnetic patterns were recorded in advance in parallel to the longitudinal direction at known intervals from each other (hereinafter, referred to as “known intervals between magnetic pattern arrays when recorded in advance”).

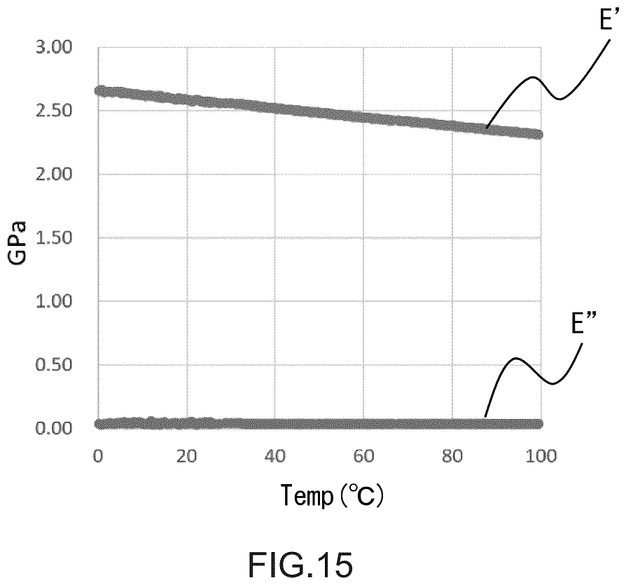

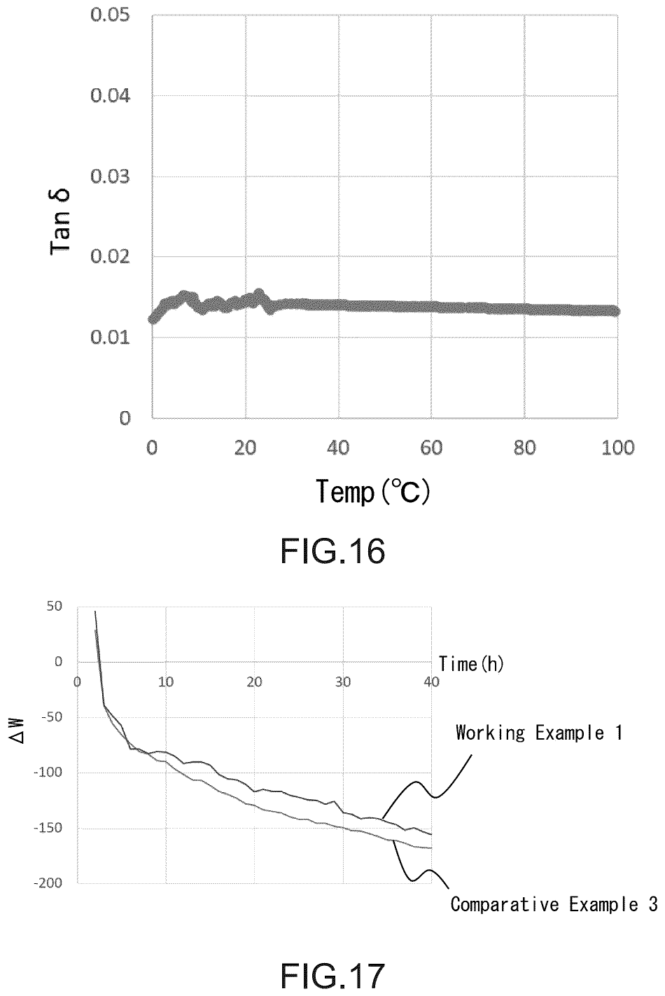

The physical properties of the magnetic tape were measured using the magnetic recording cartridge as described in “(3) Physical properties and structure” of the above 2. The measurement results thereof are shown in the following Table 1. As shown in the Table, the average value A_{(E′)} of storage elastic moduli E′ in the temperature range of 60° C. to 65° C. of the magnetic tape was 2.131, the average value A_{(E″)} of loss elastic moduli E″ was 0.024, and the average value A_{(Tanδ)} of Tanδs was 0.011. Note that plots of the storage elastic moduli E′ and the loss elastic moduli E″ measured in the dynamic mechanical analysis relative to the temperature are shown in FIG. 15. Further, plots of the Tanδs relative to the temperature are shown in FIG. 16.

Further, the average height Rpk of protruding peaks of the magnetic tape was 2.2.

Further, the width variation ΔW₄₀ₕ of the magnetic tape after 40 hours was −156 ppm. Further, the width variation for 40 hours in the measurement of the width variation ΔW₄₀ₕ is shown in FIG. 17 (plots of the width variation ΔW relative to the time t). In the figure, the width variation ΔW for 40 hours of a magnetic tape according to Comparative Example 3 described below is also shown.

### Example 2

A magnetic tape was obtained in the same manner as that in Example 1 except that inorganic additive materials contained in the magnetic layer were changed as follows.

The amount of aluminum oxide powder used in Example 1 was changed from 5 parts by mass to 4 parts by mass.

The average particle size of carbon black used in Example 1 was 120 nm, but carbon black (manufactured by Tokai Carbon Co., Ltd., product name: SEAST SP) having an average particle size of 95 nm was used instead of this. The amount of carbon black in Example 2 was the same as that in Example 1.

Further, a magnetic recording cartridge in which the magnetic tape was housed was obtained in the same manner as that in Example 1. The magnetic recording cartridge was used to measure various values in the same manner as that in Example 1. The measurement results are shown in Table 1.

### Example 3

A magnetic tape was obtained in the same manner as that in Example 1 except that inorganic additive materials contained in the magnetic layer were changed as follows.

The amount of aluminum oxide powder used in Example 1 was changed from 5 parts by mass to 3.5 parts by mass.

The average particle size of carbon black used in Example 1 was 120 nm, but carbon black (manufactured by Tokai Carbon Co., Ltd., product name: SEAST S) having an average particle size of 70 nm was used instead of this. Further, the amount of carbon black was changed from 2 parts by mass to 1.5 parts by mass.

Further, a magnetic recording cartridge in which the magnetic tape was housed was obtained in the same manner as that in Example 1. The magnetic recording cartridge was used to measure various values in the same manner as that in Example 1. The measurement results are shown in Table 1.

### Example 4

A magnetic tape was obtained in the same manner as that in Example 2 except that a PEEK film that had been stretched in the longitudinal and lateral directions was used.

Further, a magnetic recording cartridge in which the magnetic tape was housed was obtained in the same manner as that in Example 1. The magnetic recording cartridge was used to measure various values in the same manner as that in Example 1. The measurement results are shown in Table 1.

It can be seen that the storage elastic modulus can be increased by the stretching treatment. Further, it can also be seen that the loss elastic modulus, the bending rigidity, and the width variation can also be adjusted by the stretching treatment.

### Comparative Example 1

A magnetic tape was obtained in the same manner as that in Example 1 except that a PEN film was used as a support that is to be used as a base layer instead of the PEEK film.

Further, a magnetic recording cartridge in which the magnetic tape was housed was obtained in the same manner as that in Example 1. The magnetic recording cartridge was used to measure various values in the same manner as that in Example 1. The measurement results are shown in Table 1.

### Comparative Example 2

A magnetic tape was obtained in the same manner as that in Example 1 except that the amount of carbon black contained in the magnetic layer was changed from 2 parts by mass to 3 parts by mass and a PET film was used as a support that is to be used as a base layer instead of the PEEK film.

Further, a magnetic recording cartridge in which the magnetic tape was housed was obtained in the same manner as that in Example 1. The magnetic recording cartridge was used to measure various values in the same manner as that in Example 1. The measurement results are shown in Table 1.

### Comparative Example 3

A magnetic tape was obtained in the same manner as that in Example 1 except that the time of dyno mill mixing in the process of preparing a coating material for forming a magnetic layer was extended and an aramid film was used as a support that is to be used as a base layer instead of the PEEK film.

Further, a magnetic recording cartridge in which the magnetic tape was housed was obtained in the same manner as that in Example 1. The magnetic recording cartridge was used to measure various values in the same manner as that in Example 1. The measurement results are shown in Table 1.

### Comparative Example 4

A magnetic tape was obtained in the same manner as that in Example 1 except that the amount of carbon black contained in the magnetic layer was changed from 2 parts by mass to 3 parts by mass.

Further, a magnetic recording cartridge in which the magnetic tape was housed was obtained in the same manner as that in Example 1. The magnetic recording cartridge was used to measure various values in the same manner as that in Example 1. The measurement results are shown in Table 1.

### [Evaluation]

The magnetic recording cartridges produced in Examples 1 to 4 and Comparative Examples 1 to 4 were used to evaluate the full recording and reproduction properties after preservation at 65° C. and SNR of the magnetic tape housed in each cartridge. The method of evaluating the full recording and reproduction properties and the method of evaluating SNR will be described below.

### (Travelling Stability During Full Recording and Reproduction)

After preserving the magnetic recording cartridge at 65° C. and 40 RH % for two weeks, the inner roll and the outer roll were reversed while the magnetic tape is wound up by the take-up reel 32 of the magnetic recording/reproduction apparatus 30, and the magnetic recording cartridge was preserved for further two weeks. After the preservation, full recording and reproduction of the magnetic tape were performed using the magnetic recording/reproduction apparatus 30 to evaluate travelling stability of the magnetic tape.

In order to evaluate the travelling stability, a full volume test was performed on each magnetic recording cartridge 40 times. Note that in the present specification, the number of times of the full volume test is referred to also as an FV number.

In the 40 volume tests, the presence or absence of off-track during full recording and reproduction and the presence or absence of an increase in the index σsw, representing travelling stability were investigated as follows.

First, the magnetic recording cartridge was caused to travel using an LTO drive connected to a computer via serial cable communication. Of five servo bands (servo bands 0, 1, 2, 3, and 4) written on the tape, the servo band closest to the upper edge of the tape (i.e., the servo band 0) was used to activate the actuator of the drive head and cause the tape to travel such that the drive head followed the servo track. A statistical value σ_{sw-0} indicating the non-linearity of the servo pattern was measured from the servo signal obtained at that time.

Next, a statistical value σ_{sw-4} was measured using the servo band closest to the lower edge of the tape (i.e., the servo band 4).

The arithmetic mean of the statistical values σ_{sw-0} and σ_{sw-4} was used as the index σ_{sw}, indicating the travelling stability of the magnetic tape.

Note that the method of measuring the statistical value indicating the non-linearity is described in Japanese Patent Application Laid-open No. 2021-034077.

The index σ_{sw}, was obtained for all of the magnetic tapes according to Examples 1 to 3 and Comparative Examples 1 to 4 produced above.

Then, the magnetic tapes of the following examples were evaluated in accordance with the following evaluation criteria.

### <Evaluation Criteria>

The index σ_{sw}, after the 40 full volume tests was 50 nm or less: OK,
The index σ_{sw}, after the 40 full volume tests exceeded 50 nm or the test was not completed because the index σ_{sw}, exceeded 50 nm before the 40 full volume tests was completed: NG

σ_{sw} indicates the amount of deviation (error) in the read position of the servo pattern in the width direction of the magnetic recording medium 10 when the servo pattern is reproduced (read) by the recording/reproduction apparatus 30. In order to accurately adjust the tension of the magnetic recording medium 10 in the longitudinal direction, it is favorable that the linearity of the servo band when the servo pattern is read by the recording/reproduction apparatus 30 is as high as possible, i.e., the above σ_{sw} indicating the amount of deviation in the read position is as low as possible.

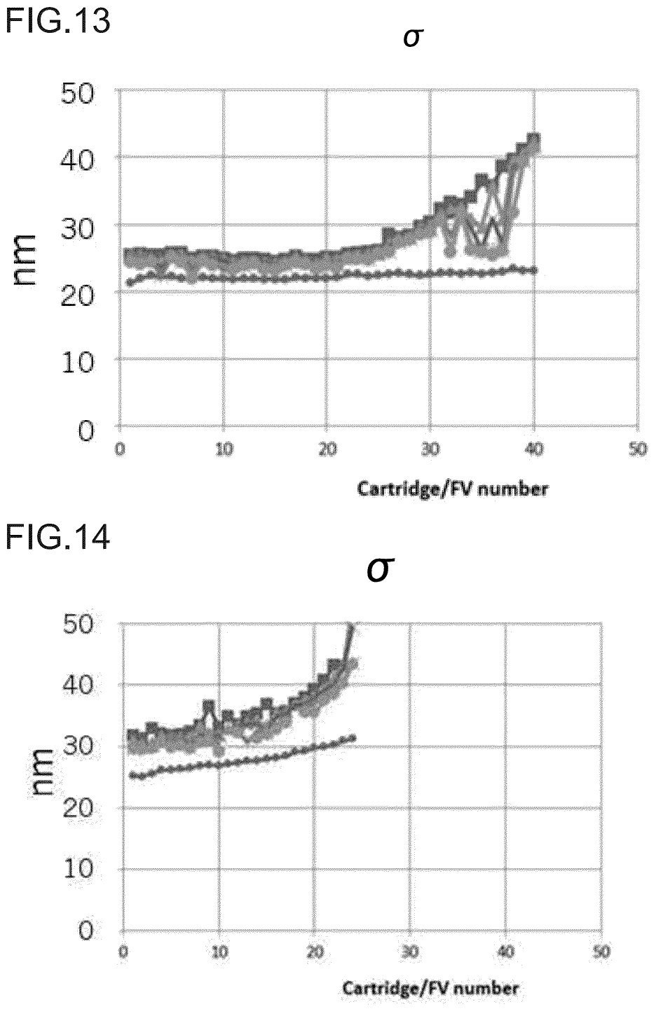

FIG. 13 is a diagram showing a change in σ_{sw} over time as the magnetic tape travels. As shown in the figure, when as when the 40 full volume tests were performed is less than 50 nm, it is evaluated that a track shift is less likely to occur and favorable travelling stability is achieved. FIG. 14 is a diagram showing a change in σs over time as the magnetic tape travels. As shown in the figure, when σ_{sw} when the 40 full volume tests were performed exceeds 50 nm, it is evaluated that travelling stability is poor because a track shift occurs frequently and thus the travelling of the magnetic tape stops.

### (SNR: Evaluation of Electromagnetic Conversion Characteristics)

First, a reproduction signal of the magnetic tape was obtained using a loop tester (manufactured by Microphysics). The conditions for acquiring the reproduction signal are shown below.
Head: GMR
Headspeed: 2 m/s
Signal: single recording frequency (10 MHz)
Recording current: Optimal recording current

Next, the reproduction signal was captured using a spectrum analyzer with a span of 0 to 20 MHz (resolution band width=100 kHz, VBW=30 kHz). Next, the peak of the captured spectrum was taken as a signal amount S, the floor noise excluding the peak was integrated to obtain a noise amount N, and a ratio S/N of the signal amount S and the noise amount N was obtained as SNR (Signal-to-Noise Ratio). Next, the obtained SNR was converted into a relative value (dB) with reference to the SNR in Comparative Example 1 as a reference medium.

These evaluation results are shown in Table 1.

### (Table 1)

TABLE 1

| | Average value | Average value | | | | | |
|---|---|---|---|---|---|---|---|
| | of storage | of loss | Average value | | | | Thickness |
| | elastic moduli | elastic muduli | of Tanδs | | Width variation | Total | of base |
| | (60-65° C.) | (60-65° C.) | (60-65° C.) | Rpk | after 40 hours | thickness | layer |
| | (GPa) | (GPa) | (GPa) | (nm) | (ppm) | (μm) | (μm) |
| Example 1 | 2.131 | 0.024 | 0.011 | 2.2 | −156 | 5.2 | 4.0 |
| Example 2 | 2.435 | 0.035 | 0.014 | 2.0 | −156 | 5.2 | 4.0 |
| Example 3 | 2.435 | 0.035 | 0.014 | 1.7 | −156 | 5.2 | 4.0 |
| Example 4 | 4.287 | 0.047 | 0.011 | 2.1 | −140 | 5.2 | 4.0 |
| Comparative | 4.947 | 0.359 | 0.073 | 2.2 | −895 | 5.2 | 4.0 |
| Example1 | | | | | | | |
| Comparative | 3.761 | 0.072 | 0.019 | 2.5 | −965 | 5.2 | 4.0 |
| Example2 | | | | | | | |
| Comparative | 9.504 | 0.442 | 0.046 | 2.4 | −168 | 5.2 | 4.0 |
| Example3 | | | | | | | |
| Comparative | 2.131 | 0.024 | 0.011 | 2.5 | −156 | 5.2 | 4.0 |
| Example4 | | | | | | | |

| | | | Full recording and | |
|---|---|---|---|---|
| | Total thickness | | reproduction properties | |
| | of magnetic layer | Bending | after preservation | |
| | and underlayer | rigidity | at 65° C. (off-track/ | SNR |
| | (μm) | (mgf/μm) | increase in σ_{sw}) | (dB) |
| Example 1 | 0.9 | 0.8 | OK | 0.6 |
| Example 2 | 0.9 | 0.8 | OK | 0.8 |
| Example 3 | 0.9 | 0.8 | OK | 1.0 |
| Example 4 | 0.9 | 1.2 | OK | 0.5 |
| Comparative | 0.9 | 1.3 | NG | 0.0 |
| Example1 | | | (Cannot follow width change | |
| | | | on EOT side and Fail occurs) | |
| Comparative | 0.9 | 1.0 | NG | 0.3 |
| Example2 | | | (Cannot follow width change | |
| | | | on EOT side and Fail occurs) | |
| Comparative | 0.9 | 1.9 | NG | −1.0 |
| Example3 | | | (σ_{sw} increases quickly due | |
| | | | to low SNR) | |
| Comparative | 0.9 | 0.8 | NG | 0.4 |
| Example4 | | | (σ_{sw} increases) | |

As shown in Table 1, the magnetic tapes according to Examples 1 to 4 had favorable full recording and reproduction properties after preservation at 65° C. That is, no off-track occurred and no increase in PES was observed. Further, the magnetic tapes according to Examples 1 to 4 had small width variations after preservation at 65° C. Further, the SNR of any of the magnetic tapes according to Examples 1 to 4 was superior to that of the magnetic tape according to Comparative Example 1.

On the other hand, in Comparative Examples 1 and 2, the degree of width change was large on the EOT side of the tape (on the side of the connection part with the reel in the cartridge. More specifically, the last part where data can be recorded, and approximately 20 m inside from the last part to be wound around the reel), and the head was unable to follow it, causing the tape to stop travelling. Further, in Comparative Examples 3 and 4, the increase in σ_{sw}, was large and σ_{sw}, exceeded 50 nm before completing the 40 full volume tests.

From these results, the magnetic recording medium according to the present technology and the magnetic recording cartridge in which the magnetic recording medium is housed have excellent preservation stability at high temperatures and excellent travelling stability after preservation at high temperatures. Further, it can be seen that the magnetic recording medium according to the present technology and the magnetic recording cartridge in which the magnetic recording medium is housed also have excellent electromagnetic conversion characteristics.

From the results shown in Table 1, it can be seen that by adjusting the average value of loss elastic moduli E″ in a temperature range of 60° C. to 65° C. and the average height Rpk of protruding peaks, it is possible to improve travelling stability after preservation in a high-temperature environment and electromagnetic conversion characteristics.

In order to achieve these effects, the average value is, for example, 0.06 GPa or less, favorably 0.05 GPa or less, more favorably 0.04 GPa or less, and still more favorably 0.03 GPa or less. Further, in order to achieve these effects, the average height Rpk of protruding peaks is, for example, 2.4 nm or less, favorably 2.3 nm or less, and more favorably 2.2 nm or less.

Further, from the results shown in Table 1, it is conceivable that adjusting the average value of storage elastic moduli E′ in a temperature range of 60° C. to 65° C. also contributes to improving travelling stability after preservation in a high-temperature environment and improving electromagnetic conversion characteristics, particularly improving electromagnetic conversion characteristics.

Favorably, the average value of storage elastic moduli E′ in a temperature range of 60° C. to 65° C. is, for example, 6 GPa or less, more favorably 5 GPa or less, still more favorably 4 GPa or less, and particularly favorably 3.5 GPa or less, 3.2 GPa or less, 3.0 GPa or less, or 2.8 GPa or less.

Further, from the results shown in Table 1, it is conceivable that adjusting the bending rigidity of the magnetic tape also contributes to improving travelling stability after preservation in a high-temperature environment and improving electromagnetic conversion characteristics, particularly improving electromagnetic conversion characteristics.

The bending rigidity is favorably 1.4 mgf/μm or less, more favorably 1.3 mgf/μm or less, still more favorably 1.2 mgf/μm or less, 1.1 mgf/μm or less, or 1.0 mgf/μm or less, and particularly favorably 0.9 mgf/μm or less or 0.8 mgf/μm or less.

Further, from the results shown in Table 1, it is conceivable that adjusting the average value of Tanδs (loss elastic modulus E″/storage elastic modulus E′) in a temperature range of 60° C. to 65° C. also contributes to improving travelling stability after preservation in a high-temperature environment and improving electromagnetic conversion characteristics.

Favorably, the average value of Tanδs in a temperature range of 60° C. to 65° C. is, for example, 0.017 or less, more favorably 0.016 or less, still more favorably 0.015 or less, and particularly favorably 0.014 or less.

Although embodiments and Examples of the present technology have been specifically described, the present technology is not limited to the above-mentioned embodiments and Examples, and various modifications based on the technical idea of the present technology can be made.

For example, the configurations, methods, processes, shapes, materials, numerical values, and the like mentioned in the above-mentioned embodiments and Examples are merely examples, and configurations, methods, processes, shapes, materials, numerical values, and the like different from these may also be used. Further, the chemical formulae of compounds and the like are representative ones, and they are not limited to the stated valances and the like as long as they are general names of the same compounds.

Further, the configurations, methods, processes, shapes, materials, numerical values, and the like in the above-mentioned embodiments and Examples can be combined with each other without departing from the essence of the present technology.

Further, in the present specification, the numerical range indicated using “to” indicates a range that respectively includes numerical values written before and after “to” as the minimum value and the maximum value. In the numerical ranges described in a stepwise manner in the present specification, the upper limit value or the lower limit value of the numerical range in one step may be replaced with the upper limit value or the lower limit value of the numerical range in another step. The materials exemplified in the present specification can be used alone or two or more of them can be used in combination, unless otherwise specified.

### REFERENCE SIGNS LIST

10 magnetic recording medium
11 base layer
12 underlayer
13 magnetic layer
14 back layer

1. A magnetic recording medium, wherein
an average value A_{(E″)} of loss elastic moduli E″ in a temperature range of 60° C. to 65° C. when dynamic mechanical analysis is performed on the magnetic recording medium at a frequency of 10 Hz and a heating rate of 2° C./min is 0.06 GPa or less, and
an average height Rpk of protruding peaks measured using a non-contact profilometer using optical interference is 2.4 nm or less.

2. The magnetic recording medium according to claim 1, wherein
an average value A_{(E′)} of storage elastic moduli E′ in a temperature range of 60° C. to 65° C. when the dynamic mechanical analysis is performed is 6 GPa or less.

3. The magnetic recording medium according to claim 1, wherein
an average value A_{(Tanδ)} of Tanδs (loss elastic modulus E″/storage elastic modulus E′) in a temperature range of 60° C. to 65° C. when the dynamic mechanical analysis is performed is 0.017 or less.

4. The magnetic recording medium according to claim 1, wherein
a base layer included in the magnetic recording medium has an average thickness t_{Base} of 4.5 μm or less.

5. The magnetic recording medium according to claim 1, wherein
an average thickness t_{T} of the magnetic recording medium is 5.3 μm or less.

6. The magnetic recording medium according to claim 1, wherein
a stiffness S of the magnetic recording medium is 1.4 mgf/μm or less.

7. The magnetic recording medium according to claim 1, wherein
the average value A_{(E″)} of loss elastic moduli E″ in a temperature range of 60° C. to 65° C. when the dynamic mechanical analysis is performed is 0.05 GPa or less.

8. The magnetic recording medium according to claim 1, wherein
the average value A_{(E″)} of loss elastic moduli E″ in a temperature range of 60° C. to 65° C. when the dynamic mechanical analysis is performed is 0.04 GPa or less.

9. The magnetic recording medium according to claim 1, wherein
the average height Rpk of protruding peaks is 2.3 nm or less.

10. The magnetic recording medium according to claim 1, wherein
the average height Rpk of protruding peaks is 2.2 nm or less.

11. The magnetic recording medium according to claim 1, wherein
an average value A_{(Tanδ)} of Tanδs when the dynamic mechanical analysis is performed is 0.016 or less.

12. The magnetic recording medium according to claim 1, wherein
an average value A_{(Tanδ)} of Tanδs when the dynamic mechanical analysis is performed is 0.015 or less.

13. The magnetic recording medium according to claim 1, which has
a width variation ΔW₄₀ₕ when a weight of 0.55 N is applied in a longitudinal direction for 40 hours in an environment of a temperature of 65° C. and a humidity of 40% satisfies a relationship of −600 ppm≤ΔW₄₀ₕ.

14. The magnetic recording medium according to claim 1, comprising
a magnetic layer that contains a magnetic powder.

15. The magnetic recording medium according to claim 1, which is a vacuum thin-film recording medium.

16. A magnetic recording cartridge, comprising:
the magnetic recording medium according to claim 1 housed in a case while being wound around a reel.
